(19) United States
(12) Patent Application Publication
(10) Pub. No.: US 2016/0241179 A1
(43) Pub. Date: Aug. 18, 2016

(54) RELUCTANCE MOTOR DRIVE CIRCUIT AND RELUCTANCE MOTOR SYSTEM

(71) Applicant: Mabuchi Motor Co., Ltd., Matsudo City (JP)

(72) Inventor: Akira Matsunawa, Matsudo City (JP)

(21) Appl. No.: 15/139,048

(22) Filed: Apr. 26, 2016

Related U.S. Application Data
(63) Continuation of application No. PCT/JP2015/068485, filed on Jun. 26, 2015.

(30) Foreign Application Priority Data
Jul. 28, 2014 (JP) 2014-153005

(51) Int. Cl. H02P 25/08

(52) U.S. Cl. CPC H02P 25/08

(57) ABSTRACT

A drive circuit is provided for a reluctance motor including a stator having multiple salient poles and a rotor having multiple salient poles, and the drive circuit includes a first path used to supply a current for excitation that flows through at least part of a coil wound around a salient pole of the stator or the rotor, and a second path used to supply a current for demagnetization that flows through a different part of the coil that does not coincide with the at least part of the coil.

### CROSS-REFERENCE TO RELATED APPLICATIONS

This application is based upon and claims the benefit of priority from the prior Japanese Patent Application No. 2014-153005, filed on Jul. 28, 2014, and International Patent Application No. PCT/JP 2015/068485, filed on Jun. 26, 2015, the entire content of each of which is incorporated herein by reference.

### BACKGROUND OF THE INVENTION

1. Field of the Invention

The present invention relates to a drive circuit for a reluctance motor that has no brush or permanent magnet and to a reluctance motor system.

2. Description of the Related Art

With the increasing costs of rare-earth materials used as magnet raw materials, switched reluctance (SR) motors devoid of permanent magnets have drawn increasing attention in recent years. An SR motor is a motor that has no permanent magnet and runs only by reluctance torque (i.e., electromagnetic attractive force). SR motors have been put into practical use for vacuum cleaners, hydraulic pumps, and electric chipping machines, for example.

In comparison with magnet motors, which are in more widespread use, SR motors have the advantage of reduced costs due to no use of permanent magnets. Also, using no permanent magnet provides SR motors with high robustness and heat resistance. There are other advantages of generating no loss due to co-rotation in a non-excitation state and generating no cogging. However, there is a problem that SR motors have lower torque density than magnet motors.

SR motors generally have higher inductance than magnet motors. Accordingly, an SR motor requires a longer convergence time from when energization of a coil is stopped and demagnetization is started until when an induced current caused by electromagnetic induction becomes zero, and also requires a longer rise time from when energization is started. Namely, the current following capability is low.

Therefore, in order not to enter a negative torque region, an SR motor is generally controlled so that energization of a coil is stopped at early timing in consideration of the current convergence time. However, when energization is stopped at early timing, the potential torque of the motor cannot be sufficiently utilized.

Also, there has been proposed a technique of using a booster circuit to boost an inverse voltage to be applied when a coil is demagnetized, in order to reduce the current convergence time (see Patent Document 1). However, the technique increases the size of the drive circuit and costs.

[Patent Document 1] Japanese Patent Application Laid-open No. 2004-208441

### SUMMARY OF THE INVENTION

The present invention has been made in view of such a situation, and a purpose thereof is to provide a technique for improving output characteristics of a reluctance motor while restraining the increase of circuit size.

One embodiment of the present invention is a drive circuit for a reluctance motor comprising a stator having a plurality of salient poles and a rotor having a plurality of salient poles, and the drive circuit comprises: a first path used to supply a current for excitation that flows through at least part of a coil wound around a salient pole of the stator or the rotor; and a second path used to supply a current for demagnetization that flows through a different part of the coil that does not coincide with the at least part of the coil. The winding may be provided around a salient pole of the stator or may be provided around a salient pole of the rotor. It may be arranged so that a current for excitation flows through the whole coil.

Optional combinations of the aforementioned constituting elements, and implementations of the present invention in the form of circuits, apparatuses, or systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are diagrams that show configurations of an SR motor according to a comparative example;

FIG. 2 is a diagram that shows a circuit configuration of a drive circuit according to a comparative example 1, which drives the SR motor shown in FIGS. 1A and 1B;

FIG. 3 is a diagram that shows operation timing of the drive circuit shown in FIG. 2;

FIG. 4 is a diagram that shows a circuit configuration of a drive circuit according to a comparative example 2, which drives the SR motor shown in FIGS. 1A and 1B;

FIG. 5 is a diagram that shows operation timing of the drive circuit shown in FIG. 4;

FIGS. 6A and 6B are diagrams that show configurations of an SR motor according to an embodiment of the present invention;

FIG. 7 is a diagram that shows a circuit configuration of a drive circuit according to an embodiment 1, which drives the SR motor shown in FIGS. 6A and 6B;

FIG. 8 is a diagram that shows operation timing of the drive circuit shown in FIG. 7;

FIG. 9 is a diagram that shows a circuit configuration of a drive circuit according to an embodiment 2, which drives the SR motor shown in FIGS. 6A and 6B;

FIG. 10 is a diagram that shows operation timing of the drive circuit shown in FIG. 9;

FIG. 11 is a diagram that shows a circuit configuration of a drive circuit according to an embodiment 3, which drives the SR motor shown in FIGS. 6A and 6B;

FIG. 12 is a diagram that shows operation timing of the drive circuit shown in FIG. 11;

FIGS. 13A and 13B are diagrams in which coil currents according to a comparative example are compared with coil currents according to a present embodiment;

FIG. 14 is a diagram that shows a modification 1 of the drive circuit shown in FIG. 7;

FIG. 15 is a diagram that shows a modification 2 of the drive circuit shown in FIG. 7;

FIG. 16 is a diagram that shows a circuit configuration of a drive circuit according to a comparative example 3, which drives the SR motor shown in FIGS. 1A and 1B;

FIG. 17 is a diagram that shows operation timing of the drive circuit shown in FIG. 16;

FIG. 18 is a diagram used to describe a problem of the drive circuit shown in FIG. 16;

FIG. 19 is a diagram that shows a circuit configuration of a drive circuit according to an embodiment 4, which drives the SR motor shown in FIGS. 1A and 1B;

FIG. 20 is a diagram that shows operation timing of the drive circuit shown in FIG. 19;

FIG. 21 is a diagram that shows a circuit configuration of a drive circuit according to an embodiment 5, which drives the SR motor shown in FIGS. 6A and 6B;

FIG. 22 is a diagram that shows operation timing of the drive circuit shown in FIG. 21;

FIG. 23 is a diagram that shows a circuit configuration of a drive circuit according to an embodiment 6, which drives the SR motor shown in FIGS. 6A and 6B;

FIG. 24 is a diagram that shows operation timing of the drive circuit shown in FIG. 23;

FIG. 25 is a diagram that shows a circuit configuration of a drive circuit according to an embodiment 7, which drives the SR motor shown in FIGS. 1A and 1B;

FIG. 26 is a diagram that shows operation timing of the drive circuit shown in FIG. 25;

FIG. 27 is a diagram that shows a circuit configuration of a drive circuit according to an embodiment 8, which drives the SR motor shown in FIGS. 6A and 6B;

FIG. 28 is a diagram that shows operation timing of the drive circuit shown in FIG. 27;

FIG. 29 is a diagram that shows a circuit configuration of a drive circuit according to a modification of the modification 2; and

FIGS. 30A-30C are diagrams in which output characteristics of the drive circuits shown in FIGS. 2, 15, and 29 are compared with one another.

### DETAILED DESCRIPTION OF THE INVENTION

The invention will now be described by reference to the preferred embodiments. This does not intend to limit the scope of the present invention, but to exemplify the invention.

To solve the problems above, one embodiment of the present invention is a drive circuit for a reluctance motor comprising a stator having a plurality of salient poles and a rotor having a plurality of salient poles, and the drive circuit comprises: a first path used to supply a current for excitation that flows through at least part of a coil wound around a salient pole of the stator or the rotor; and a second path used to supply a current for demagnetization that flows through a different part of the coil that does not coincide with the at least part of the coil. The winding may be provided around a salient pole of the stator or may be provided around a salient pole of the rotor. It may be arranged so that a current for excitation flows through the whole coil.

According to this embodiment, when a coil is demagnetized, an induced current can be emitted using a smaller number of turns of the coil, so that a period until the current converges can be reduced. Therefore, a longer excitation time can be ensured, and the output characteristics can be improved.

The drive circuit may comprise: a first switching element provided between a first end of the coil and a high side reference line connected to the positive side of a power supply; a current control element provided between a second end of the coil and the high side reference line to send a current from the coil to the high side reference line; and a second switching element provided between a connection point in the coil and a low side reference line connected to the negative side of the power supply. Accordingly, a drive circuit for providing the aforementioned effects can be implemented by three elements.

The drive circuit may have a mode in which the first switching element and the second switching element are turned on and a mode in which turning on and turning off of the second switching element are alternately repeated while the first switching element is in the ON state, when the coil is excited. Accordingly, a drive circuit of which the output characteristics can be changed by changing an ON/OFF duty ratio can be obtained.

The drive circuit may comprise: a first switching element provided between a first end of the coil and a high side reference line connected to the positive side of a power supply; a second switching element provided between a second end of the coil and a low side reference line connected to the negative side of the power supply; a first current control element that sends a current from the low side reference line to a first connection point in the coil; and a second current control element that sends a current from a second connection point of the coil that is positioned closer to the second end than the first connection point is, to the high side reference line. Accordingly, a drive circuit for providing the aforementioned effects can be implemented by four elements.

The first current control element may be a first diode of which the anode terminal is connected to the low side reference line and of which the cathode terminal is connected to the connection point of the coil. Also, the second current control element may be a second diode of which the anode terminal is connected to the connection point of the coil and of which the cathode terminal is connected to the high side reference line. By using diodes, costs can be reduced compared to the case of using active elements.

The first current control element may be a third switching element with which a diode is formed or connected in parallel. Also, the second current control element may be a second diode of which the anode terminal is connected to the connection point of the coil and of which the cathode terminal is connected to the high side reference line. By using the third switching element as the first current control element, a current for excitation can be made to flow through part of the coil.

The drive circuit may have two modes in which the number of turns used for excitation of the coil is different. By turning on the third switching element for excitation of the coil, a mode in which a current rises quickly can be selected.

The first switching element, the second switching element, the first current control element, and the second current control element may be provided for each phase of the stator. Also, the first switching element or the second switching element may be shared in a plurality of phases in which excitation periods of the coils do not overlap with each other. Accordingly, the number of switching elements can be reduced.

Another embodiment of the present invention is also a drive circuit for a reluctance motor. The drive circuit is for a reluctance motor comprising a stator having a plurality of salient poles and a rotor having a plurality of salient poles, and the drive circuit comprises: a first path used to supply a current from a high side reference line connected to the positive side of a power supply, via at least part of a coil wound around a salient pole of the stator or the rotor, to a low side reference line connected to the negative side of the power supply; a second path used to supply a current from the low side reference line, via a different part of the coil that does not coincide with the at least part of the coil, to the high side reference line; and switching means that performs switching between the connection of the first path and the connection of the second path. Inductance in the second path is less than or equal to inductance in the first path, and the direction of a current flowing through the coil is the same in the first path and the second path.

According to this embodiment, inductance in the demagnetization path can be made smaller, so that time until the current converges can be reduced. Therefore, a longer excitation time can be ensured, and the output characteristics can be improved.

A reluctance motor system of yet another embodiment of the present invention comprises: a reluctance motor comprising a stator having a plurality of salient poles and a rotor having a plurality of salient poles; and an aforementioned drive circuit that drives the reluctance motor.

This embodiment provides a reluctance motor system in which output characteristics are improved while an increase of the size of the drive circuit is restrained.

Optional combinations of the aforementioned constituting elements, and implementations of the present invention in the form of circuits, apparatuses, or systems may also be practiced as additional modes of the present invention.

In the following, embodiments of the present invention will be described with reference to the drawings. In the drawings, like reference characters designate like or corresponding elements, and the description thereof will not be repeated for brevity. Also, the configurations described below are intended to be illustrative only and do not provide any limitation on the scope of the present invention.

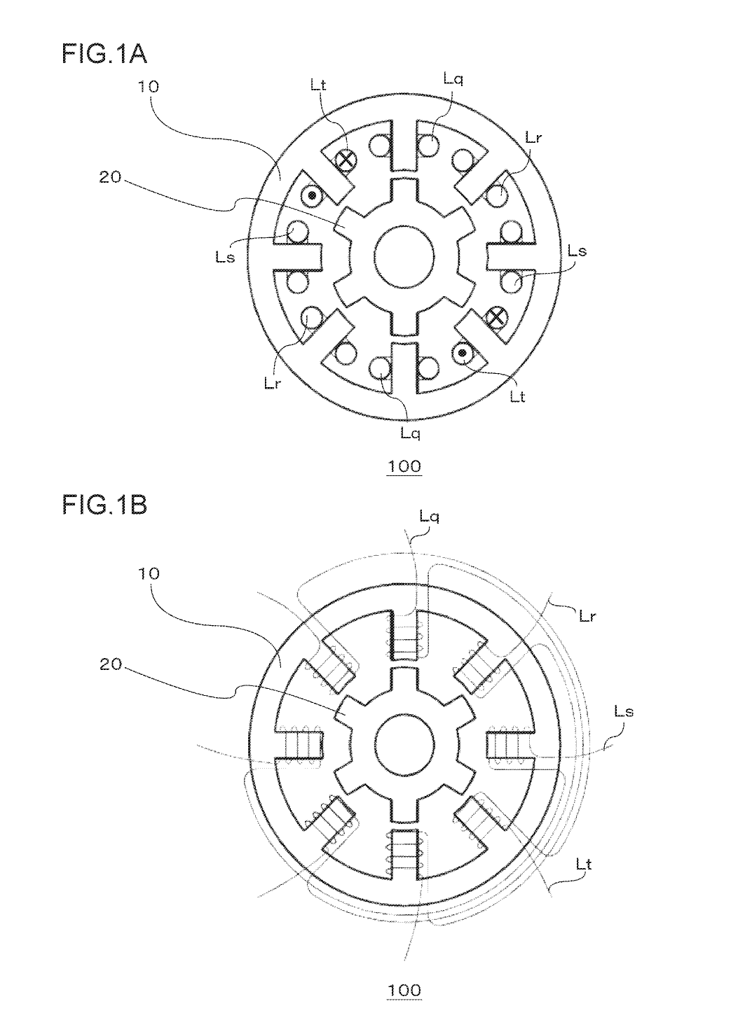

FIGS. 1A and 1B are diagrams that show configurations of an SR motor 100 according to a comparative example. The SR motor 100 comprises a combination of a stator 10 having a plurality of salient poles provided at regular intervals and a rotor 20 also having a plurality of salient poles provided at regular intervals. FIGS. 1A and 1B show an example of the SR motor 100 comprising the stator 10 with eight poles and the rotor 20 with six poles. Around each salient pole (formed with an iron core, for example) of the stator 10, a coil is wound. In this example, a coil is wound around two salient poles that are opposed to each other and separated by 180 degrees, so that the motor is four-phase driven. FIG. 1B shows an example of windings of a Q-phase coil Lq, an R-phase coil Lr, an S-phase coil Ls, and a T-phase coil Lt, and FIG. 1A shows cross sections of the Q-phase coil Lq, R-phase coil Lr, S-phase coil Ls, and T-phase coil Lt wound around the respective salient poles.

The SR motor 100 is not limited to the four-phase drive type having the stator 10 with eight poles and the rotor 20 with six poles, and there are various types including a three-phase drive type having the stator 10 with six poles and the rotor 20 with four poles and a two-phase drive type having the stator 10 with four poles and the rotor 20 with two poles. Also, the motor may be configured to have coils wound around salient poles of the rotor. In this case, a brush and a slip ring need to be provided to feed power to a coil.

The rotor 20 is made of a soft magnetic material, such as a magnetic steel sheet. Generally, the motor is designed so that the number of poles of the rotor 20 differs from the number of poles of the stator 10. Accordingly, a no-torque state caused by all the poles matching between the rotor 20 and the stator 10 can be prevented. In the SR motor 100, the salient poles of the rotor 20 are attracted by reluctance torque generated by energizing the coils wound around the salient poles of the stator 10, so that the rotor 20 is rotated.

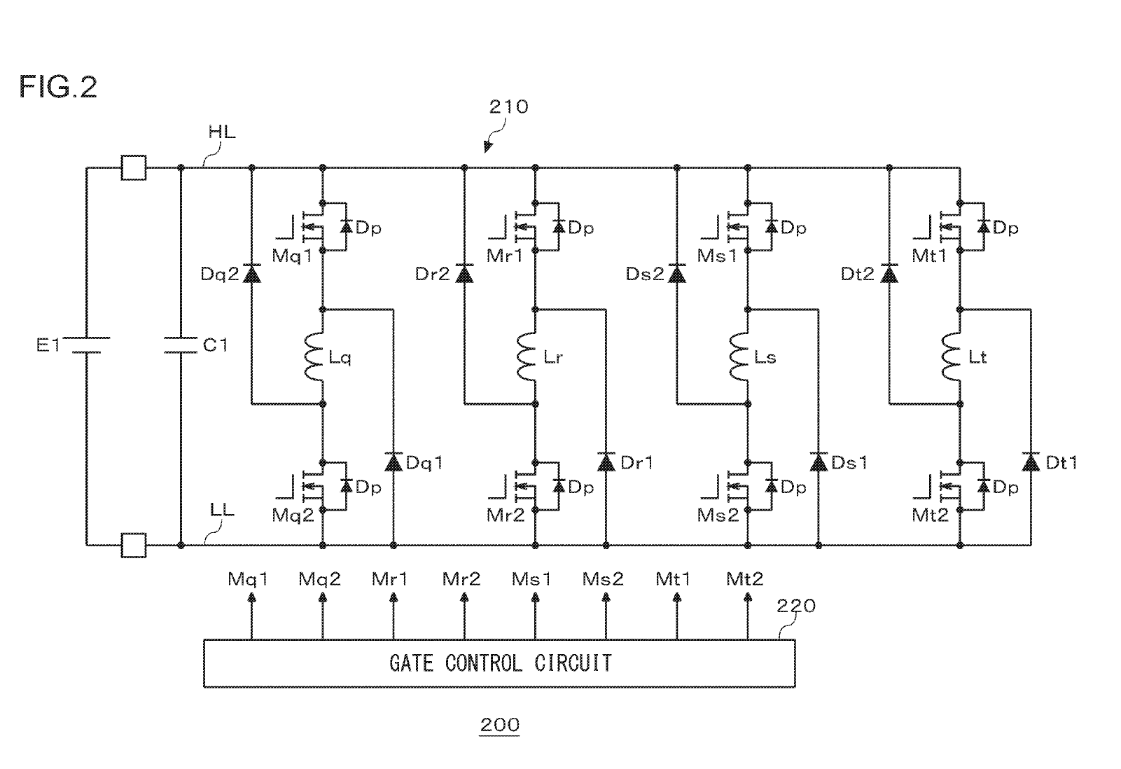

FIG. 2 is a diagram that shows a circuit configuration of a drive circuit 200 according to a comparative example 1, which drives the SR motor 100 shown in FIGS. 1A and 1B. The drive circuit 200 for the SR motor 100 comprises a bridge circuit unit 210 and a gate control circuit 220. In the present specification, a combination of the SR motor 100 and the drive circuit 200 will be referred to as a motor system.

In the bridge circuit unit 210, the Q-phase coil Lq, R-phase coil Lr, S-phase coil Ls, and T-phase coil Lt of the SR motor 100 are provided between a high side reference line HL (power supply potential line) connected to the positive side of a DC power supply E1 and a low side reference line LL (ground line) connected to the negative side of the DC power supply E1.

Between a first end (the upper end) of the Q-phase coil Lq and the high side reference line HL, a Q-phase first switching element Mq1 is provided. Also, between a second end (the lower end) of the Q-phase coil Lq and the low side reference line LL, a Q-phase second switching element Mq2 is provided. In the comparative example 1, n-channel MOSFETs are used for the Q-phase first switching element Mq1 and Q-phase second switching element Mq2. In an n-channel MOSFET, a parasitic diode Dp is formed between the source and the drain with the direction from the source to the drain as the forward direction.

Also, IGBTs may be used for switching elements. Since a parasitic diode is not formed in an IGBT, when an effect of the aforementioned parasitic diode is needed, a diode is connected in parallel with the IGBT between the emitter and the collector with the direction from the emitter to the collector as the forward direction. Also when a relay is used for a switching element, a diode is connected in parallel with the relay.

Between the upper end of the Q-phase coil Lq and the low side reference line LL, a Q-phase first current control element Dq1 is provided to send a current in the direction from the low side reference line LL to the upper end of the Q-phase coil Lq. Also, between the lower end of the Q-phase coil Lq and the high side reference line HL, a Q-phase second current control element Dq2 is provided to send a current in the direction from the lower end of the Q-phase coil Lq to the high side reference line HL.

In the comparative example 1, diodes are used for the Q-phase first current control element Dq1 and Q-phase second current control element Dq2. The anode terminal of a Q-phase first diode as the Q-phase first current control element Dq1 is connected to the low side reference line LL, and the cathode terminal of the Q-phase first diode is connected to the upper end of the Q-phase coil Lq. Also, the anode terminal of a Q-phase second diode as the Q-phase second current control element Dq2 is connected to the lower end of the Q-phase coil Lq, and the cathode terminal of the Q-phase second diode is connected to the high side reference line HL.

In this way, the Q-phase coil Lq, Q-phase first switching element Mq1, Q-phase second switching element Mq2, Q-phase first current control element Dq1, and Q-phase second current control element Dq2 constitute a Q-phase asymmetric bridge circuit.

A configuration similar to that of the Q phase is provided for each of the R, S, and T phases. Namely, the R-phase coil Lr, an R-phase first switching element Mr1 an R-phase second switching element Mr2, an R-phase first current control element Dr1, and an R-phase second current control element Dr2 constitute an R-phase asymmetric bridge circuit; similarly, the S-phase coil Ls, an S-phase first switching element Ms1, an S-phase second switching element Ms2, an S-phase first current control element Ds1, and an S-phase second current control element Ds2 constitute an S-phase asymmetric bridge circuit; and similarly, the T-phase coil Lt, a T-phase first switching element Mt1, a T-phase second switching element Mt2, a T-phase first current control element Dt1, and a T-phase second current control element Dt2 constitute a T-phase asymmetric bridge circuit. The SR motor 100 shown in FIG. 1 is driven by these four asymmetric bridge circuits.

Between the high side reference line HL and low side reference line LL, a smoothing capacitor C1 is connected. The gate control circuit 220 controls the ON/OFF state of the Q-phase first switching element Mq1, Q-phase second switching element Mq2, R-phase first switching element Mr1, R-phase second switching element Mr2, S-phase first switching element Ms1, S-phase second switching element Ms2, T-phase first switching element Mt1, and T-phase second switching element Mt2. In the comparative example 1, a gate drive voltage (hereinafter, referred to as a gate signal) is supplied to the gate terminal of each MOSFET so as to control the ON/OFF state of the MOSFET. When a bipolar transistor is used for a switching element, a base current is supplied to control the ON/OFF state of the bipolar transistor.

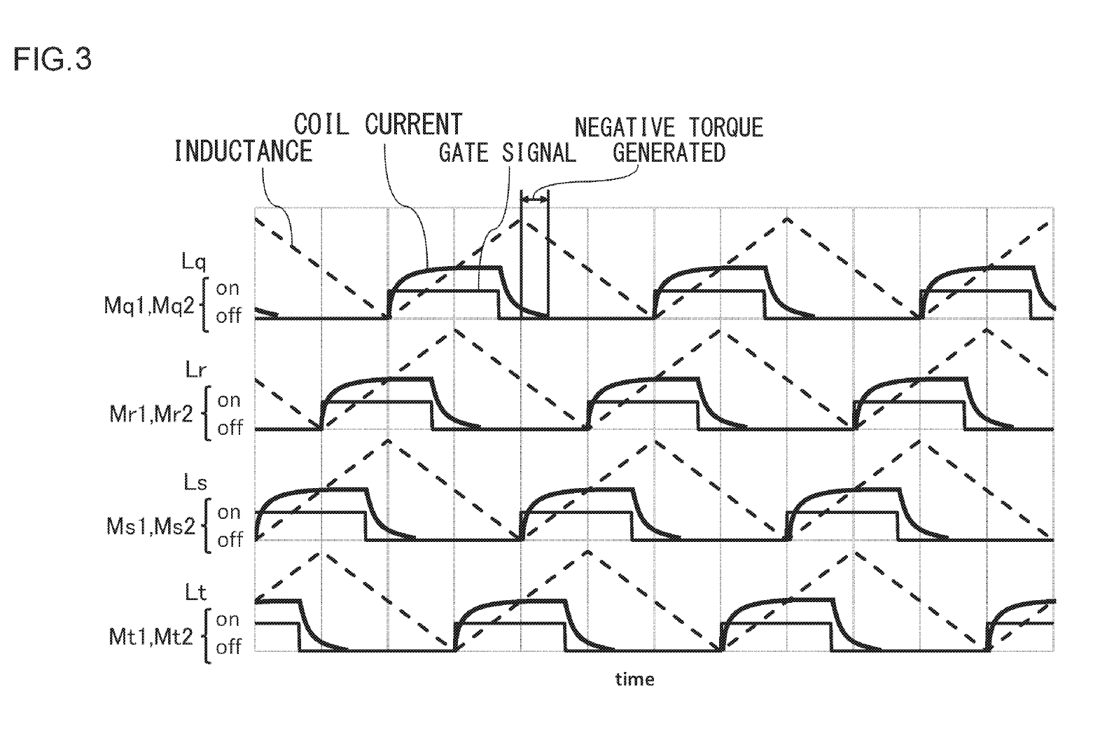

FIG. 3 is a diagram that shows operation timing of the drive circuit 200 shown in FIG. 2. When a high-level gate signal is supplied from the gate control circuit 220 to the gate terminal of the Q-phase first switching element Mq1 and the gate terminal of the Q-phase second switching element Mq2, the Q-phase first switching element Mq1 and Q-phase second switching element Mq2 are switched to the ON state. In this state, a current from the DC power supply E1 flows through the Q-phase coil Lq, thereby generating magnetic flux proportional to the current.

Meanwhile, when a low-level gate signal is supplied from the gate control circuit 220 to the gate terminal of the Q-phase first switching element Mq1 and the gate terminal of the Q-phase second switching element Mq2, the Q-phase first switching element Mq1 and Q-phase second switching element Mq2 are switched to the OFF state. In this state, the current flowing into the Q-phase coil Lq is shut off, thereby generating an induced voltage corresponding to a change in magnetic flux through the Q-phase coil Lq. The induced voltage then generates an induced current, which is fed back to the DC power supply E1 and the capacitor C1 through a closed loop formed by the Q-phase coil Lq, Q-phase first current control element Dq1, DC power supply E1, and Q-phase second current control element Dq2.

In a configuration in which the Q-phase first current control element Dq1 and Q-phase second current control element Dq2 are not provided and, for demagnetization, the Q-phase coil Lq is simply electrically connected to a ground line, the magnetic flux is greatly changed and a surge voltage is generated the moment the switching elements are turned off. Also, in a configuration in which a closed loop for demagnetization is formed only by the Q-phase coil Lq and a diode for electrically connecting the both ends of the Q-phase coil Lq, since a current flows with an induced voltage merely exceeding a forward voltage drop (Vf) of the diode, the magnetic flux is changed moderately. In this case, the convergence time required until the induced current becomes zero will be increased.

In the configuration in which a closed loop is formed by the Q-phase coil Lq, Q-phase first current control element Dq1, DC power supply E1, and Q-phase second current control element Dq2, on the other hand, an induced voltage exceeding the voltage of the DC power supply E1 is required. Accordingly, compared to the aforementioned configuration in which a closed loop is formed by the Q-phase coil Lq and a diode, the magnetic flux is changed more greatly and the current convergence time can be reduced. However, since the SR motor 100 has high inductance, such reduction of the current convergence time does not suffice. The above description also applies to the phases other than the Q phase.

In order to maximally utilize the potential torque of the SR motor 100, it is ideal to excite a coil with a conduction angle of 180 degrees for each phase. Namely, it is ideal to energize a coil wound around a salient pole of the stator 10 to attract a salient pole of the rotor 20 and then shut off the current at the time when the salient pole of the stator 10 and the salient pole of the rotor 20 are perfectly opposed to each other. However, it takes time after the current is shut off until an induced current generated in the coil converges. While the induced current flows, a salient pole of the stator 10 provides negative torque to a salient pole of the rotor 20 that has passed the salient pole of the stator 10. In order to avoid such a situation, the timing of shutting off the current to the coil may be advanced in consideration of the current convergence time. In this case, however, the potential torque of the SR motor 100 cannot be maximally utilized.

A pulse waveform indicated by a thin line in FIG. 3 represents a gate signal supplied to the gate terminal of each switching element. A waveform indicated by a thick line represents a coil current of which conduction or non-conduction is controlled by the relevant switching element. A characteristic indicated by a dotted line represents inductance of the relevant coil. Inductance is indicated linearly for the sake of convenience, although it does not actually change linearly. Inductance changes according to the positional relationship between a salient pole of the stator 10 and a salient pole of the rotor 20; inductance is maximized when a salient pole of the stator 10 and a salient pole of the rotor 20 are opposed to each other and is decreased as the relationship is shifted so that the salient pole of the stator 10 is opposed to a recess position (between salient poles) of the rotor 20.

As shown in FIG. 3, the four phase coils are energized at different times shifted by 90 degrees as the electric angle. In the graph of FIG. 3, one division in the horizontal direction corresponds to 90 degrees as the electric angle. The timing chart of FIG. 3 shows an example in which the four phase coils are controlled with 150-degree conduction. Namely, each switching element is turned off at a point 30 degrees before 180 degrees. However, the current does not reach zero yet at the timing of 180 degrees, causing negative torque.

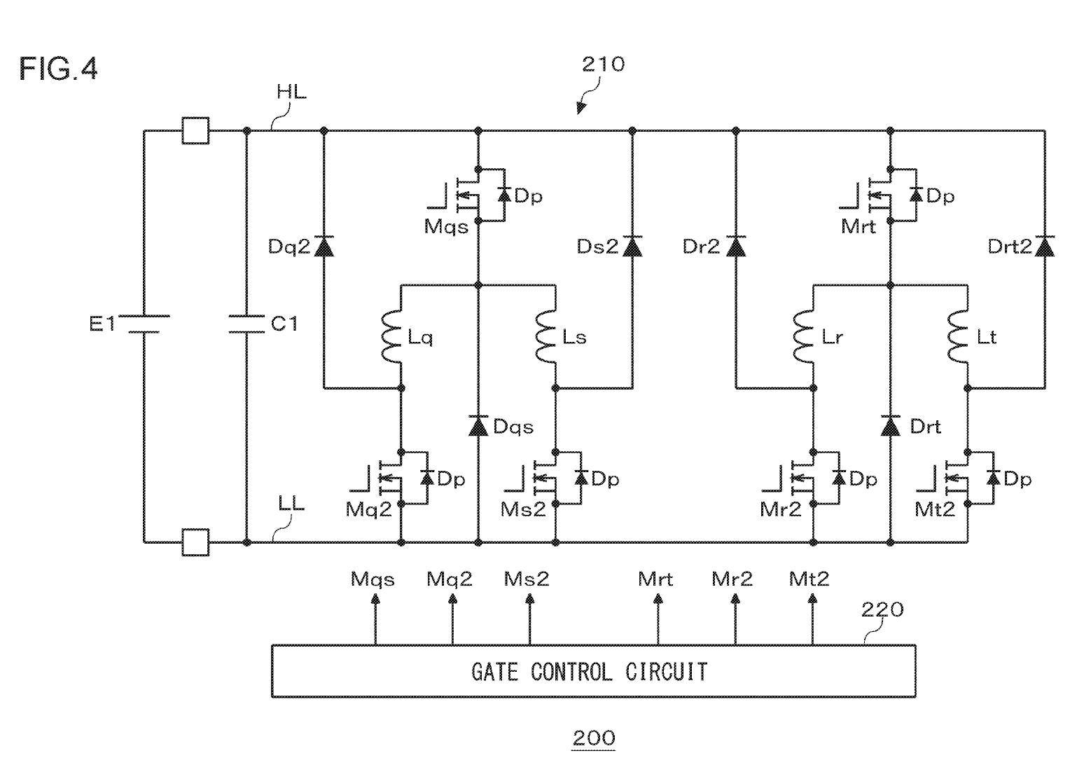

FIG. 4 is a diagram that shows a circuit configuration of the drive circuit 200 according to a comparative example 2, which drives the SR motor 100 shown in FIGS. 1A and 1B. The drive circuit 200 according to the comparative example 2 has a configuration in which a first switching element (high side switching element) is shared by two phase circuits in which the excitation periods of the coils do not overlap with each other in the drive circuit 200 according to the comparative example 1 shown in FIG. 2. In the configuration, a second current control element is also shared by the two phase circuits in which the excitation periods of the coils do not overlap with each other.

With reference to FIG. 3, the conduction periods in the Q phase and S phase do not overlap with each other, and the conduction periods in the R phase and T phase also do not overlap with each other. Accordingly, the Q-phase first switching element Mq1 and the S-phase first switching element Mq1 are replaced by a QS-phase common switching element Mqs. Also, the Q-phase second current control element Dq2 and the S-phase second current control element Ds2 are replaced by a QS-phase common current control element Dqs. Similarly, the R-phase first switching element Mr1 and the T-phase first switching element Mt1 are replaced by an RT-phase common switching element Mrt. Also, the R-phase second current control element Dr2 and the T-phase second current control element Dt2 are replaced by an RT-phase common current control element Drt. Compared to the circuit configuration shown in FIG. 2, necessary parts can be reduced in this circuit configuration, so that the costs can also be reduced.

If the operation is changed so that a coil is excited with a conduction angle of 90 degrees or less for each phase, since the conduction periods in the four phases do not overlap with each other, the switching elements and current control elements can be partly shared by the four phase circuits. However, since the conduction period is shorter, the output will be smaller.

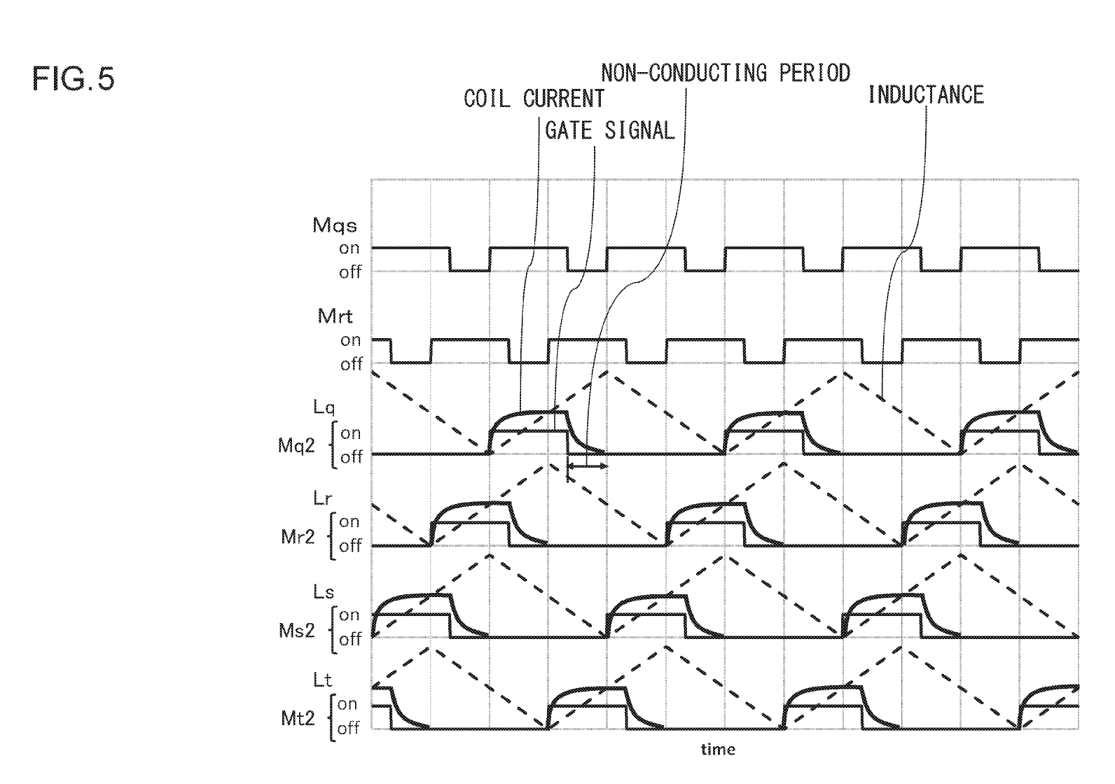

FIG. 5 is a diagram that shows operation timing of the drive circuit 200 shown in FIG. 4. This timing chart shows an example in which the four phase coils are controlled with 120-degree conduction. Namely, each switching element is turned off at a point 60 degrees before 180 degrees. When a switching element is shared, before the coil current of one phase reaches zero, energization of a coil of the other phase cannot be started; therefore, the conduction time is set shorter. Accordingly, the conduction period is shorter than that of 150-degree conduction shown in FIG. 3. Consequently, the positive torque proportional to the positive coil current becomes smaller, so that the use efficiency of the potential torque is further reduced.

Although FIGS. 4 and 5 show a configuration in which high side switching elements are shared, low side switching elements and first current control elements may also be shared.

As stated above, negative torque is caused or the use efficiency of potential torque is reduced because of a longer period after energization of a coil is stopped until the current converges. In the following, a method for making a current fall steeper will be described.

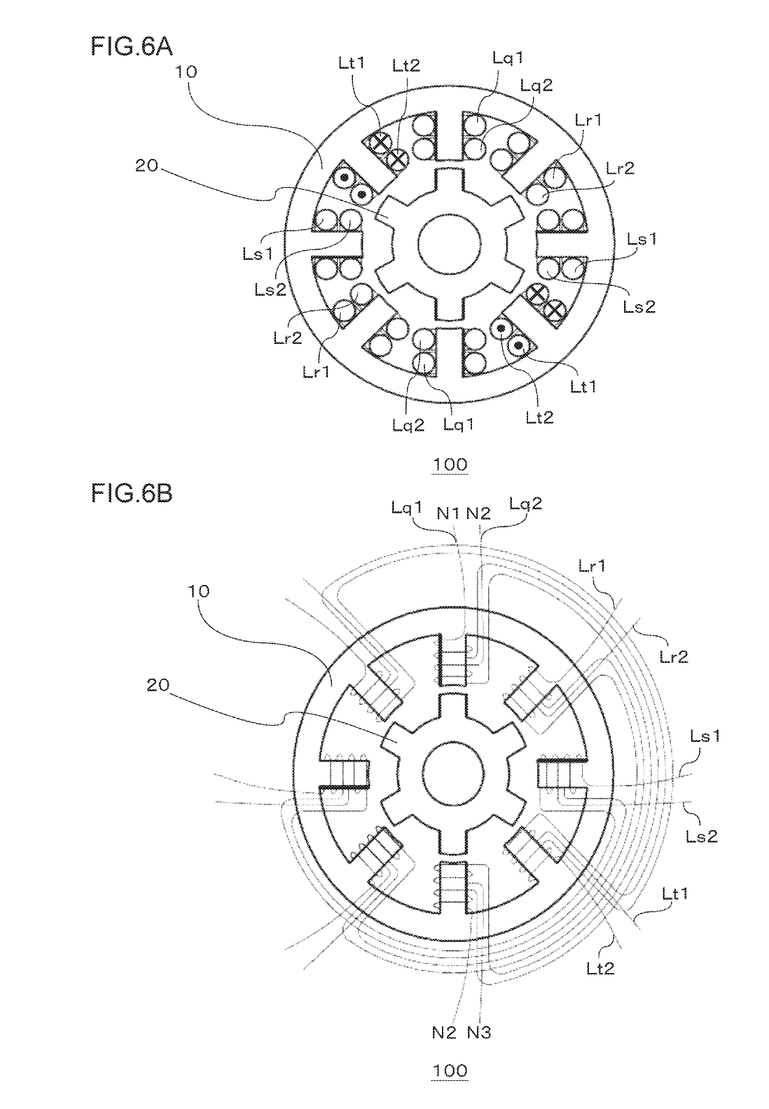

FIGS. 6A and 6B are diagrams that show configurations of the SR motor 100 according to an embodiment of the present invention. Compared to the SR motor 100 according to a comparative example shown in FIGS. 1A and 1B, the SR motor 100 according to an embodiment shown in FIGS. 6A and 6B has a junction point within each of the Q-phase coil Lq, R-phase coil Lr, S-phase coil Ls, and T-phase coil Lt.

More specifically, the Q-phase coil Lq is separated at the junction point into a first Q-phase coil section Lq1 and a second Q-phase coil section Lq2. Similarly, the R-phase coil Lr is separated at the junction point into a first R-phase coil section Lr1 and a second R-phase coil section Lr2, the S-phase coil Ls is separated at the junction point into a first S-phase coil section Ls1 and a second S-phase coil section Ls2, and the T-phase coil Lt is separated at the junction point into a first T-phase coil section Lt1 and a second T-phase coil section Lt2.

In the interest of simplicity, it is here assumed that the junction point is provided in each coil at a position where the number of turns is half the total number of turns. It is also assumed that the sum of the number of turns of the first coil section and the number of turns of the second coil section is equal to the number of turns of the coil before the separation.

In FIG. 6B, the first Q-phase coil section Lq1 and second Q-phase coil section Lq2 are wound in parallel around two salient poles separated by 180 degrees. A similar configuration is provided for each of the other phases.

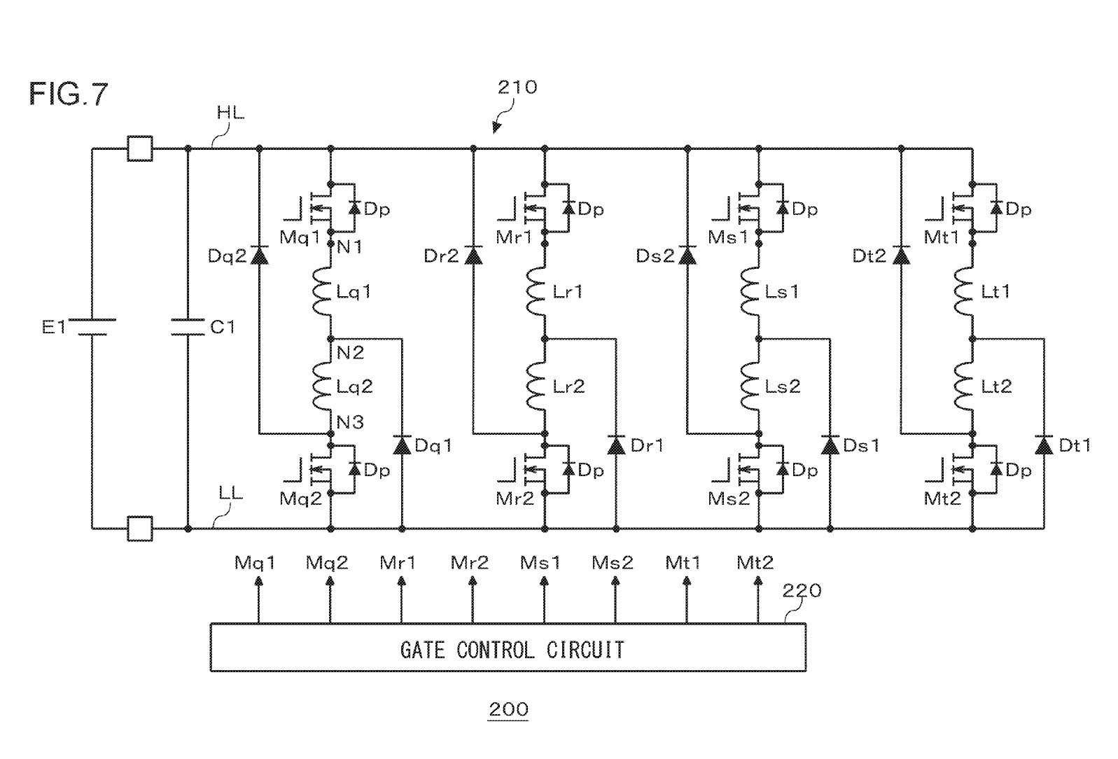

FIG. 7 is a diagram that shows a circuit configuration of the drive circuit 200 according to an embodiment 1, which drives the SR motor 100 shown in FIGS. 6A and 6B. In the following, differences from the circuit configuration of the drive circuit 200 according to the comparative example 1 shown in FIG. 2 will be described.

In the comparative example 1, the Q-phase first current control element Dq1 is provided between the upper end of the Q-phase coil Lq and the low side reference line LL; however, in the embodiment 1, the Q-phase first current control element Dq1 is provided between the junction point (a second node N2) of the Q-phase coil Lq and the low side reference line LL. The junction point of the Q-phase coil Lq also corresponds to a connection point of the first Q-phase coil section Lq1 and the second Q-phase coil section Lq2.

As shown in FIGS. 6B and 7, the source terminal of the Q-phase first switching element Mq1 is connected to a first node N1, to which the upper end of the first Q-phase coil section Lq1 is connected, and the cathode terminal of the Q-phase first current control element Dq1 and the upper end of the second Q-phase coil section Lq2 are connected to the second node N2, to which the lower end of the first Q-phase coil section Lq1 is connected. Also, the anode terminal of the Q-phase second current control element Dq2 and the drain terminal of the Q-phase second switching element Mq2 are connected to a third node N3, to which the lower end of the second Q-phase coil section Lq2 is connected. A configuration similar to that of the Q phase is provided for each of the R, S, and T phases.

With this circuit configuration, when the energization of the Q-phase coil Lq is stopped, an induced current is emitted from the both ends of the second Q-phase coil section Lq2, instead of the both ends of the Q-phase coil Lq. The number of turns of the second Q-phase coil section Lq2 is smaller than that of the Q-phase coil Lq and is half the number of turns of the Q-phase coil Lq in the embodiment 1. Accordingly, the inductance will be halved, so that the current convergence time after the energization is stopped can also be reduced by almost half.

Since the first Q-phase coil section Lq1 and the second Q-phase coil section Lq2 are magnetically coupled, an induced current based on magnetic energy stored in the first Q-phase coil section Lq1 is emitted from the second Q-phase coil section Lq2. The total amount of the magnetic energy in the first Q-phase coil section Lq1 and the second Q-phase coil section Lq2 is equal to the total amount of the magnetic energy in the Q-phase coil Lq, and the current convergence time is reduced by almost half, so that the peak value of the emission current will be almost doubled. Since part of magnetic energy in the first Q-phase coil section Lq1 may cause a small surge voltage, a surge absorbing element may be provided in parallel with the first Q-phase coil section Lq1.

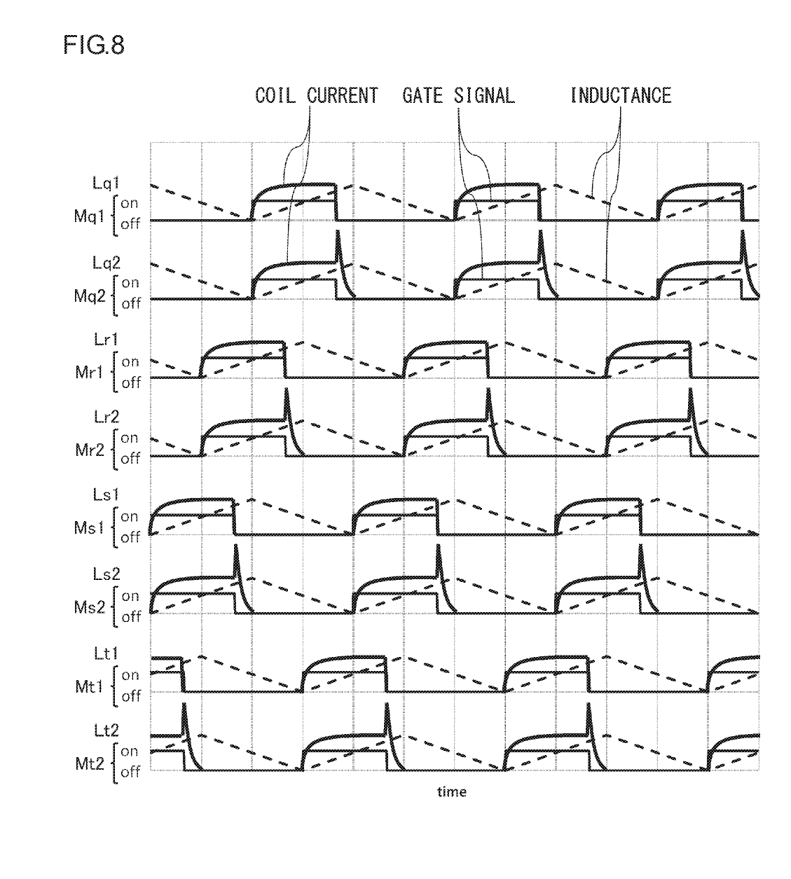

FIG. 8 is a diagram that shows operation timing of the drive circuit 200 shown in FIG. 7. As with the timing chart of FIG. 3, the timing chart of FIG. 8 also shows an example in which the four phase coils are controlled with 150-degree conduction. Each phase coil is separated into a first coil section and a second coil section. The inductance of each coil section is about a half of the inductance of the corresponding coil in the timing chart of FIG. 3. Since the first coil sections are not used for emission of magnetic energy, no current flows through the first coil sections as the energization is stopped. In the second coil sections, on the other hand, when the energization is stopped, the current momentarily increases and then steeply decreases. Accordingly, although the coils are controlled with 150-degree conduction in the same way as in the timing chart of FIG. 3, the currents converge to zero at the timing of 180 degrees in the timing chart of FIG. 8. Consequently, negative torque is not caused.

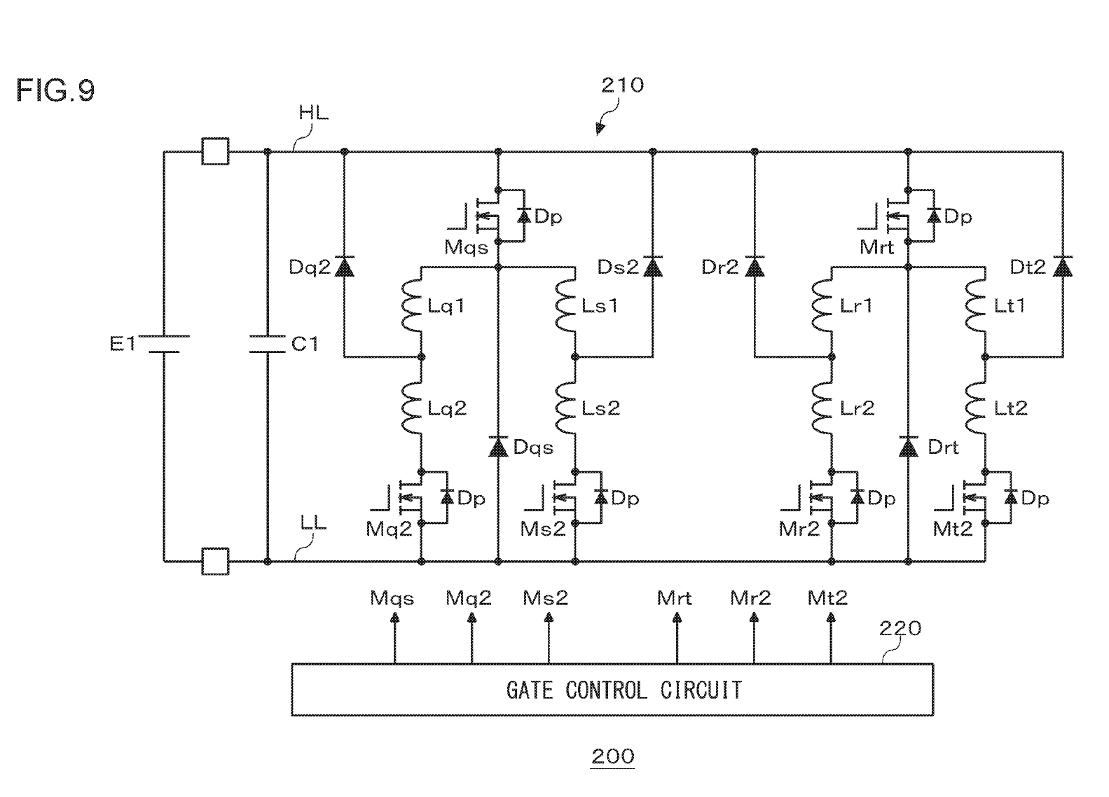

FIG. 9 is a diagram that shows a circuit configuration of the drive circuit 200 according to an embodiment 2, which drives the SR motor 100 shown in FIGS. 6A and 6B. In the following, differences from the circuit configuration of the drive circuit 200 according to the comparative example 2 shown in FIG. 4 will be described.

In the comparative example 2, the Q-phase second current control element Dq2 is provided between the lower end of the Q-phase coil Lq and the high side reference line HL; however, in the embodiment 2, the Q-phase second current control element Dq2 is provided between the junction point of the Q-phase coil Lq and the high side reference line HL. A configuration similar to that of the Q phase is provided for each of the R, S, and T phases.

With this circuit configuration, when the energization of the Q-phase coil Lq is stopped, an induced current is emitted from the both ends of the first Q-phase coil section Lq1, instead of the both ends of the Q-phase coil Lq. The number of turns of the first Q-phase coil section Lq1 is smaller than that of the Q-phase coil Lq and is half the number of turns of the Q-phase coil Lq in the embodiment 2. Accordingly, the inductance will be halved, so that the current convergence time after the energization is stopped can also be reduced by almost half.

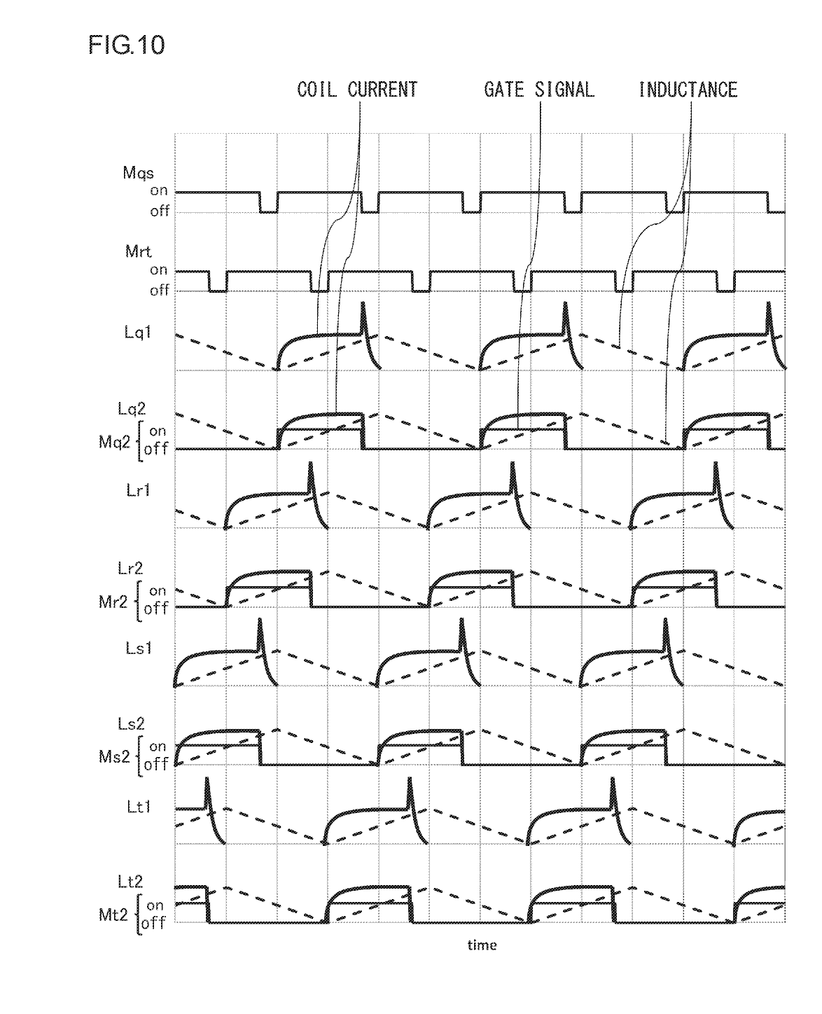

FIG. 10 is a diagram that shows operation timing of the drive circuit 200 shown in FIG. 9. As with the timing chart of FIG. 8, the timing chart of FIG. 10 also shows an example in which the four phase coils are controlled with 150-degree conduction. Since magnetic energy is emitted using the first coil sections in the embodiment 2, the current waveforms of the first coil sections and the current waveforms of the second coil sections are inverted in FIG. 10 compared to those in the timing chart of FIG. 8. Except for the shared first switching elements, the timing chart of FIG. 10 shows characteristics similar to those in the timing chart of FIG. 8.

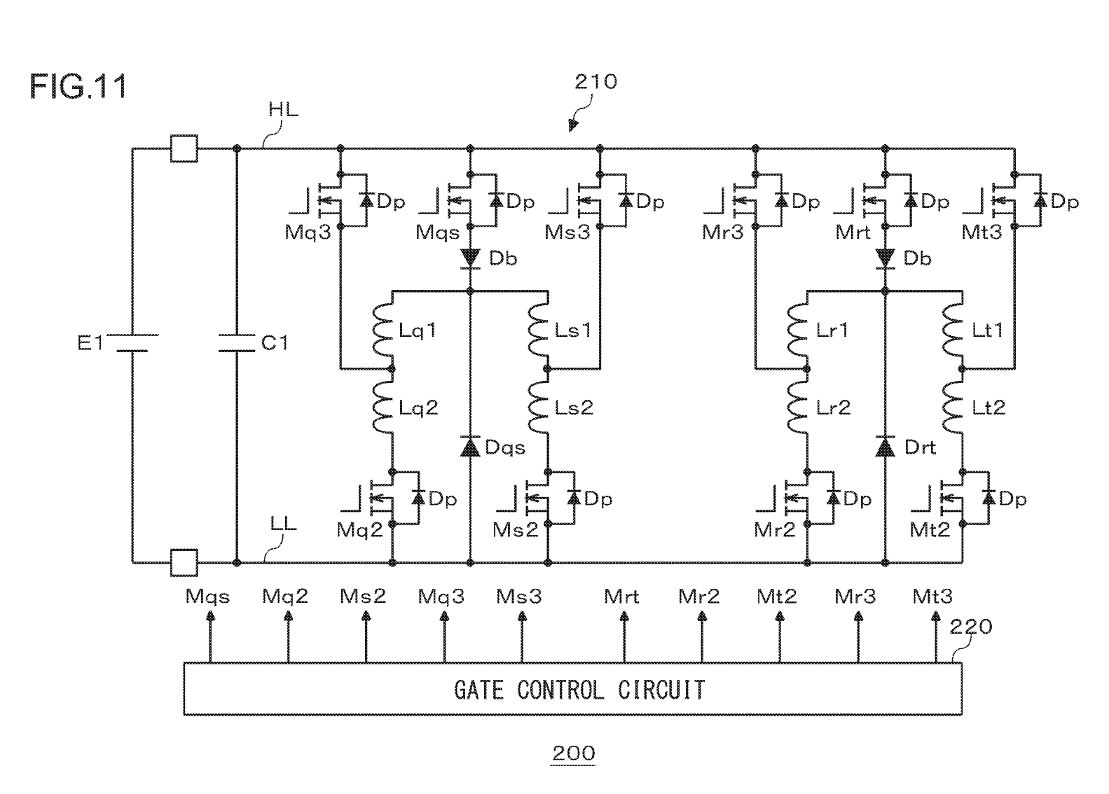

FIG. 11 is a diagram that shows a circuit configuration of the drive circuit 200 according to an embodiment 3, which drives the SR motor 100 shown in FIGS. 6A and 6B. In the following, differences from the circuit configuration of the drive circuit 200 according to the embodiment 2 shown in FIG. 8 will be described.

Although a diode as the Q-phase second current control element Dq2 is used in the embodiment 2, a Q-phase third switching element Mq3 is used instead in the embodiment 3. In parallel with the Q-phase third switching element Mq3, a diode needs to be connected or formed with the direction from the junction point between the first Q-phase coil section Lq1 and second Q-phase coil section Lq2 to the high side reference line HL as the forward direction. In FIG. 11, an n-channel MOSFET is used. In the n-channel MOSFET, a parasitic diode Dp is formed with the direction from the junction point to the high side reference line HL as the forward direction. Similarly to the Q phase, an R-phase third switching element Mr3, an S-phase third switching element Ms3, and a T-phase third switching element Mt3 are used instead of the R-phase second current control element Dr2, S-phase second current control element Ds2, and T-phase second current control element Dt2 in the R, S, and T phases, respectively.

Between the QS-phase common switching element Mqs and the connection point of the first Q-phase coil section Lq1 and the first S-phase coil section Ls1, a diode Db for backflow prevention is provided. Similarly, between the RT-phase common switching element Mrt and the connection point of the first R-phase coil section Lr1 and the first T-phase coil section Lt1, a diode Db for backflow prevention is also provided.

When the Q-phase third switching element Mq3, R-phase third switching element Mr3, S-phase third switching element Ms3, and T-phase third switching element Mt3 are continuously set to the OFF state, the operation timing is the same as that in the embodiment 2 shown in FIG. 9.

In the embodiment 3, a current rise time when a coil is excited can also be reduced. In the embodiment 2, when the Q-phase coil Lq is excited, for example, the QS-phase common switching element Mqs and the Q-phase second switching element Mq2 are turned on. In the embodiment 3, the Q-phase third switching element Mq3 and the Q-phase second switching element Mq2 are turned on while the QS-phase common switching element Mqs is maintained in the OFF state, so that a current flows through the both ends of the second Q-phase coil section Lq2.

In the embodiment 3, a current for excitation flows through the both ends of the second Q-phase coil section Lq2, instead of the both ends of the Q-phase coil Lq. The number of turns of the second Q-phase coil section Lq2 is smaller than that of the Q-phase coil Lq and is half the number of turns of the Q-phase coil Lq in the embodiment 3. Accordingly, the inductance will be halved, so that the current rise time after energization is started can also be reduced by almost half. The first Q-phase coil section Lq1 and the second Q-phase coil section Lq2 are magnetically coupled.

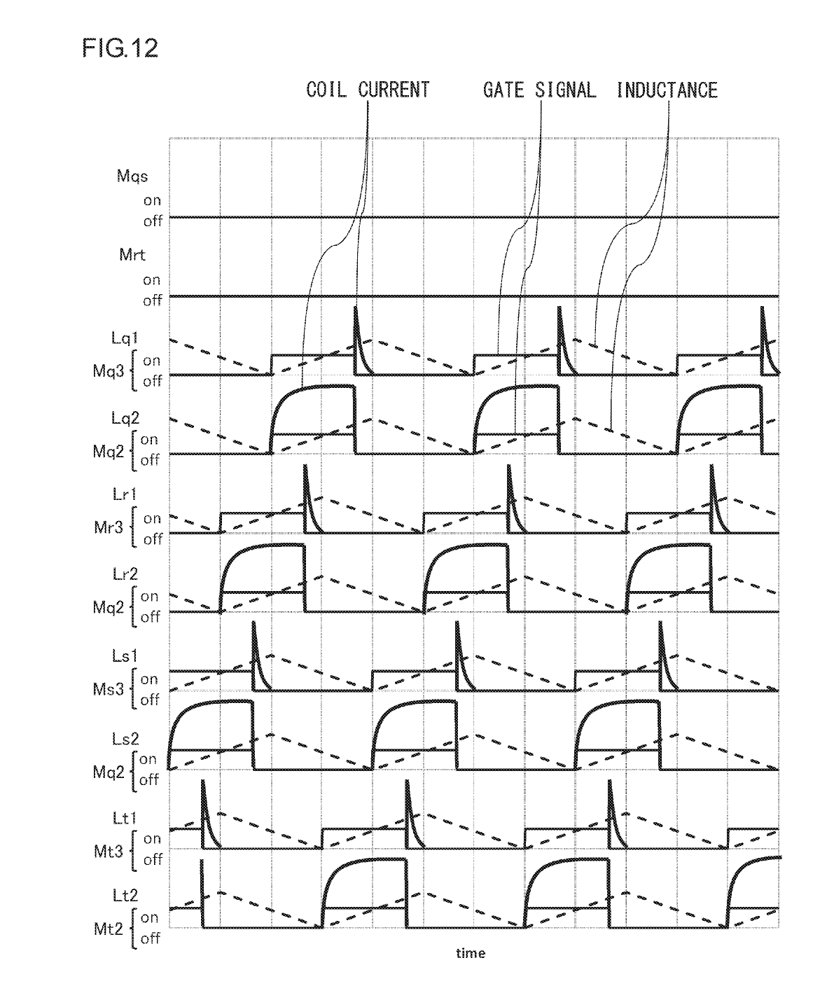

FIG. 12 is a diagram that shows operation timing of the drive circuit 200 shown in FIG. 11. As with the timing charts of FIGS. 8 and 10, the timing chart of FIG. 12 also shows an example in which the four phase coils are controlled with 150-degree conduction. In the timing chart of FIG. 12, the QS-phase common switching element Mqs and the RT-phase common switching element Mrt are continuously set to the OFF state. In the embodiment 3, currents for excitation flow through the second coil sections but do not flow through the first coil sections. Since the total amount of the magnetic energy is equal to that in the case where currents for excitation flow through the whole coils, greater amounts of currents flow through the second coil sections in the embodiment 3.

For demagnetization, the Q-phase third switching element Mq3 is turned off and the Q-phase second switching element Mq2 is also turned off, and the magnetic energy is emitted using the first coil section. Since the second coil sections are not used for emission of magnetic energy, no current flows through the second coil sections as the energization is stopped. In the first coil sections, on the other hand, when the energization is stopped, the current momentarily increases and then steeply decreases.

Since a current rise time when a coil is excited can be reduced in the embodiment 3, the SR motor 100 can be rotated at high speed.

With the circuit configuration shown in FIG. 11, the operation mode can be switched between a normal rotation mode and a high speed rotation mode. Namely, the SR motor 100 is driven with the operation timing shown in FIG. 10 in the normal rotation mode and driven with the operation timing shown in FIG. 12 in the high speed rotation mode.

As described above, according to the present embodiments, the current convergence time can be reduced by decreasing the number of turns of a coil used for emission of an induced current when the coil is demagnetized, so that the output characteristics of the SR motor 100 can be improved.

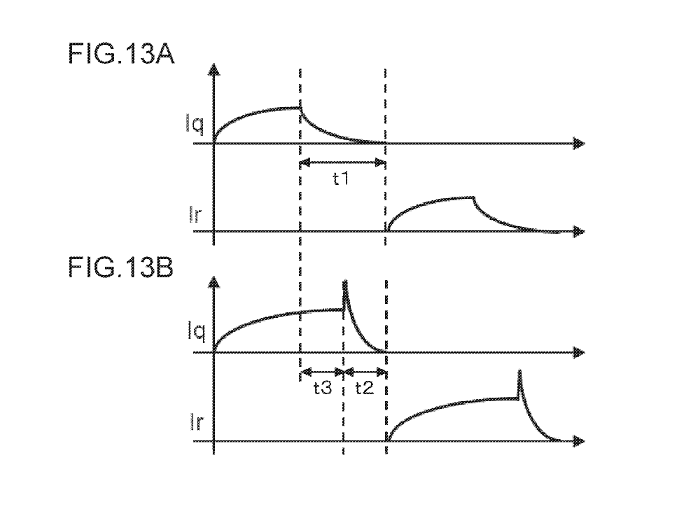

FIGS. 13A and 13B are diagrams in which coil currents according to a comparative example are compared with coil currents according to a present embodiment. FIGS. 13A and 13B show the coil currents of the Q phase and R phase for the sake of convenience. FIG. 13A shows the coil currents according to a comparative example, and FIG. 13B shows the coil currents according to a present embodiment. When FIGS. 13A and 13B are compared, the current convergence time t2 according to a present embodiment in FIG. 13B is shorter than the current convergence time t1 according to a comparative example in FIG. 13A. This is because the number of turns of a coil used for emission of an induced current is decreased in the embodiments. The time obtained by the reduction of the current convergence time T2 will be an increase time t3 of the excitation time, so that a longer excitation time can be ensured in the driving system according to an embodiment, compared to the driving system according to a comparative example. Accordingly, loss of the potential torque is reduced, so that the output characteristics of the SR motor 100 can be improved.

As the number of turns of a coil used for emission of an induced current is decreased, the current convergence time can be reduced. However, since the amount of magnetic energy to be emitted is the same and the emission time is reduced, the peaks of the induced voltage and induced current become larger. In such a case, switching elements and diodes with high breakdown voltages need to be used, so that the circuit area and costs will be increased. Therefore, a designer may determine the number of turns of a coil used for emission of an induced current within acceptable ranges of the circuit size and costs.

The current convergence time can be reduced also by increasing an inverse voltage applied to a coil when the coil is demagnetized. In this case, however, a booster circuit is additionally required, so that the size of the drive circuit and costs will be increased. In the present embodiments, the current convergence time is reduced without increasing the size of the drive circuit and costs.

The present invention has been described with reference to the aforementioned embodiments. However, the present invention is not limited thereto and also includes a form resulting from appropriate combination or replacement of the configurations in the embodiments. It is also to be understood that appropriate changes of the combination or the order of processes in each embodiment or various modifications, including design modifications, may be made based on the knowledge of those skilled in the art and that such changes and modifications also fall within the scope of the present invention.

As described previously, the SR motor 100 according to a present embodiment is provided with a configuration in which the number of turns of a coil used for emission of an induced current is decreased. The configuration is not limited to that in which a junction point is provided in a coil at a position where the number of turns is half the total number of turns, as set forth above. Also, two junction points may be provided instead of one junction point.

Namely, between a node (hereinafter, referred to as a node A) of a coil to which a first current control element, connected to the low side reference line LL, is connected and a node (hereinafter, referred to as a node B) of the coil to which a second current control element, connected to the high side reference line HL, is connected, only the following relationships need to hold: the node A is positioned closer to the upper end of the coil than the node B is; and the number of turns between the node A and node B is smaller than the number of turns between the upper end and lower end of the coil. As long as these two conditions are met, the positions of the node A and node B may be arbitrarily designed. In the circuit configuration shown in FIG. 7, for example, the node A is set to the midpoint of the coil, and the node B is set to the lower end of the coil.

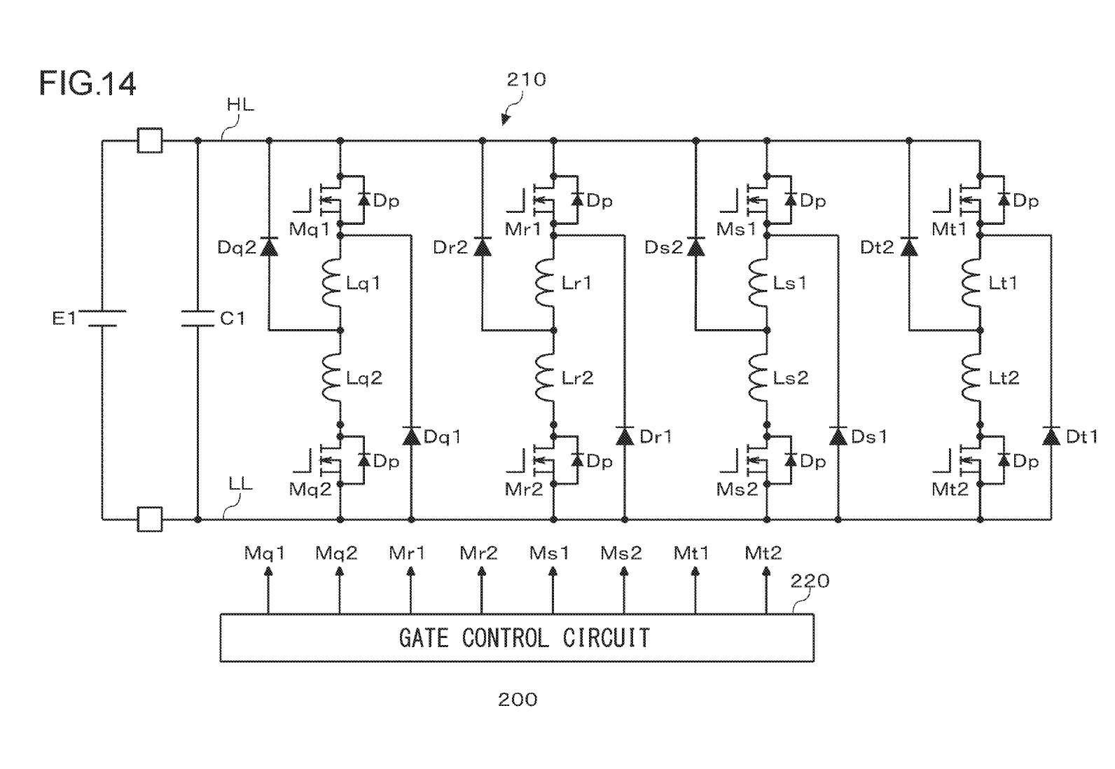

FIG. 14 is a diagram that shows a modification 1 of the drive circuit 200 shown in FIG. 7. In the modification 1, the node A is set to the upper end of a coil, and the node B is set to the midpoint of the coil.

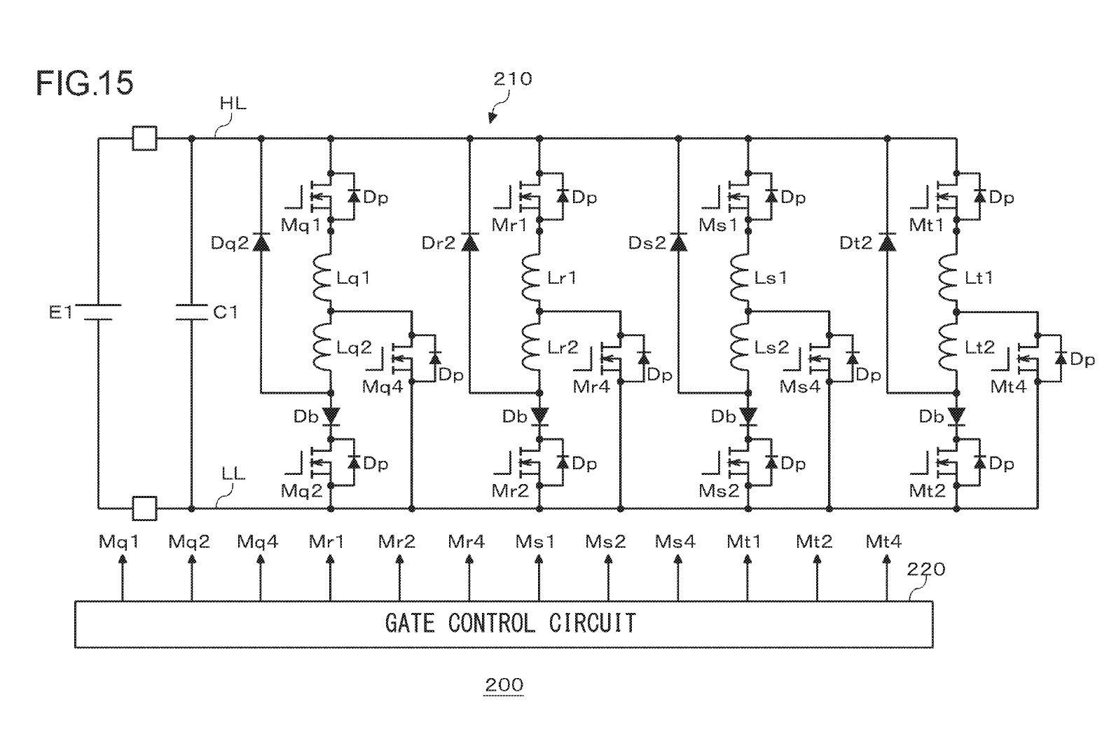

FIG. 15 is a diagram that shows a modification 2 of the drive circuit 200 shown in FIG. 7. In the modification 2, the node A is set to the midpoint of a coil, and the node B is set to the lower end of the coil, as with in the circuit configuration shown in FIG. 7. Although a diode as the Q-phase first current control element Dq1 is used in the drive circuit 200 shown in FIG. 7, a Q-phase fourth switching element Mq4 is used instead in the modification 2. In parallel with the Q-phase fourth switching element Mq4, a diode needs to be connected or formed with the direction from the low side reference line LL to the junction point between the first Q-phase coil section Lq1 and second Q-phase coil section Lq2 as the forward direction. In FIG. 15, an n-channel MOSFET is used. In the n-channel MOSFET, a parasitic diode Dp is formed with the direction from the low side reference line LL to the junction point as the forward direction. Similarly to the Q phase, an R-phase fourth switching element Mr4, an S-phase fourth switching element Ms4, and a T-phase fourth switching element Mt4 are used instead of the R-phase first current control element Dr1, S-phase first current control element Ds1, and T-phase first current control element Dt1 in the R, S, and T phases, respectively.

Between the second Q-phase coil section Lq2 and the Q-phase second switching element Mq2, a diode Db for backflow prevention is provided. Similarly, a diode Db for backflow prevention is also provided between the second R-phase coil section Lr2 and the R-phase second switching element Mr2, between the second S-phase coil section Ls2 and the S-phase second switching element Ms2, and between the second T-phase coil section Lt2 and the T-phase second switching element Mt2.

In the modification 2, a current rise time when a coil is excited can be reduced, as with in the embodiment 3. When the Q-phase coil Lq is excited in the modification 2, for example, the Q-phase first switching element Mq1 and the Q-phase fourth switching element Mq4 are turned on while the Q-phase second switching element Mq2 is maintained in the OFF state, so that a current flows through the both ends of the first Q-phase coil section Lq1. As with in the embodiment 3, the operation mode can be switched between the normal rotation mode and the high speed rotation mode in the modification 2.

With the drive circuit 200 according to the comparative example 1 shown in FIG. 2, an example in which eight MOSFETs and eight diodes are used has been described. Also, with the drive circuit 200 according to the comparative example 2 shown in FIG. 4, an example in which the number of MOSFETs and the number of diodes are reduced by sharing parts of the circuits has been described. Compared to the comparative example 1, the number of MOSFETs can be reduced by two and the number of diodes can also be reduced by two in the comparative example 2. In the following, a method for further reducing the number of elements will be described.

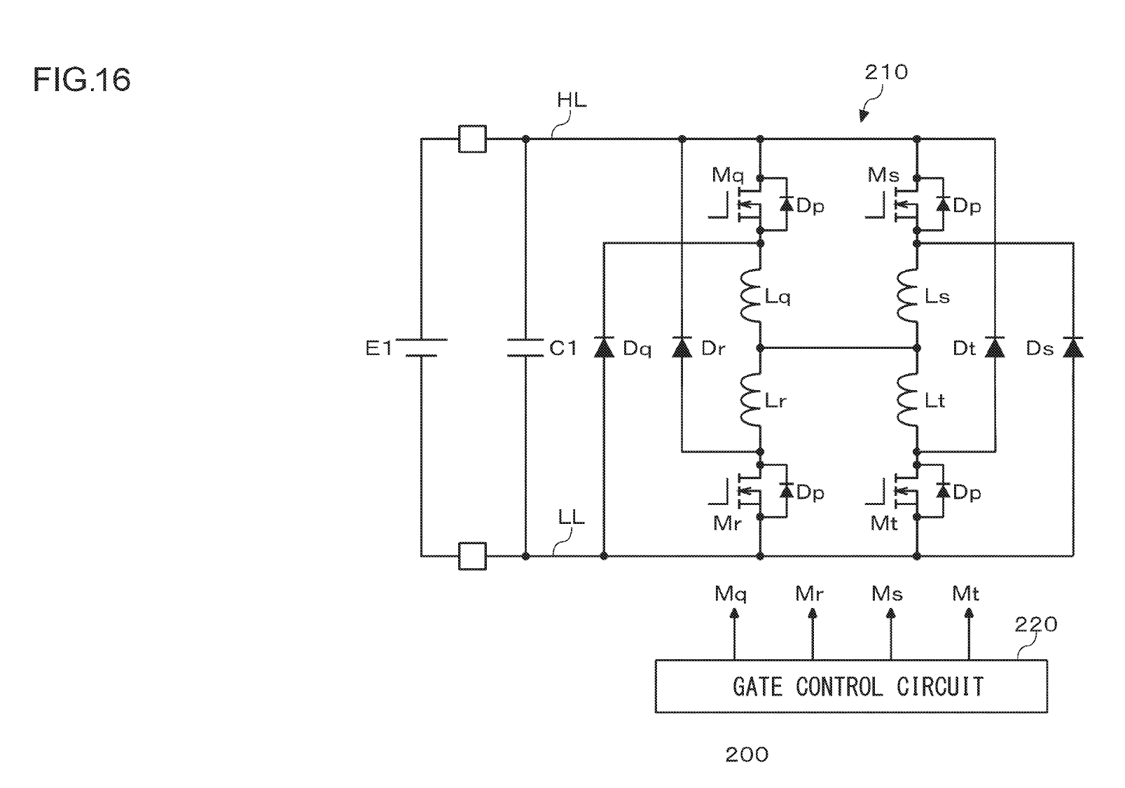

FIG. 16 is a diagram that shows a circuit configuration of the drive circuit 200 according to a comparative example 3, which drives the SR motor 100 shown in FIGS. 1A and 1B. In the bridge circuit unit 210 according to the comparative example 3, the Q-phase coil Lq and R-phase coil Lr connected in series are arranged in parallel with the S-phase coil Ls and T-phase coil Lt connected in series, between the high side reference line HL connected to the positive side of the DC power supply E1 and the low side reference line LL connected to the negative side of the DC power supply E1. A node between the Q-phase coil Lq and R-phase coil Lr is connected to a node between the S-phase coil Ls and T-phase coil Lt, so that one end of each of the four coils is connected to each other.

Between the upper end of the Q-phase coil Lq and the high side reference line HL, a Q-phase switching element Mq is provided. The lower end of the Q-phase coil Lq is connected to the upper end of the R-phase coil Lr. Also, between the lower end of the R-phase coil Lr and the low side reference line LL, an R-phase switching element Mr is provided. Also in the comparative example 3, n-channel MOSFETs are used for the Q-phase switching element Mr and R-phase switching element Mr.

Between the upper end of the Q-phase coil Lq and the low side reference line LL, a Q-phase current control element Dq is provided to send a current in the direction from the low side reference line LL to the upper end of the Q-phase coil Lq. Also, between the lower end of the R-phase coil Lr and the high side reference line HL, an R-phase current control element Dr is provided to send a current in the direction from the lower end of the R-phase coil Lr to the high side reference line HL. Also in the comparative example 3, diodes are used for the Q-phase current control element Dq and R-phase current control element Dr.

Similarly, between the upper end of the S-phase coil Ls and the high side reference line HL, an S-phase switching element Ms is provided. The lower end of the S-phase coil Ls is connected to the upper end of the T-phase coil Lt. Also, between the lower end of the T-phase coil Lt and the low side reference line LL, a T-phase switching element Mt is provided. Also in the comparative example 3, n-channel MOSFETs are used for the S-phase switching element Ms and T-phase switching element Mt.

Between the upper end of the S-phase coil Ls and the low side reference line LL, an S-phase current control element Ds is provided to send a current in the direction from the low side reference line LL to the upper end of the S-phase coil Ls. Also, between the lower end of the T-phase coil Lt and the high side reference line HL, a T-phase current control element Dt is provided to send a current in the direction from the lower end of the T-phase coil Lt to the high side reference line HL. Also in the comparative example 3, diodes are used for the S-phase current control element Ds and T-phase current control element Dt.

Between the high side reference line HL and low side reference line LL, a smoothing capacitor C1 is connected. The gate control circuit 220 controls the ON/OFF state of the Q-phase switching element Mq, R-phase switching element Mr, S-phase switching element Ms, and T-phase switching element Mt.

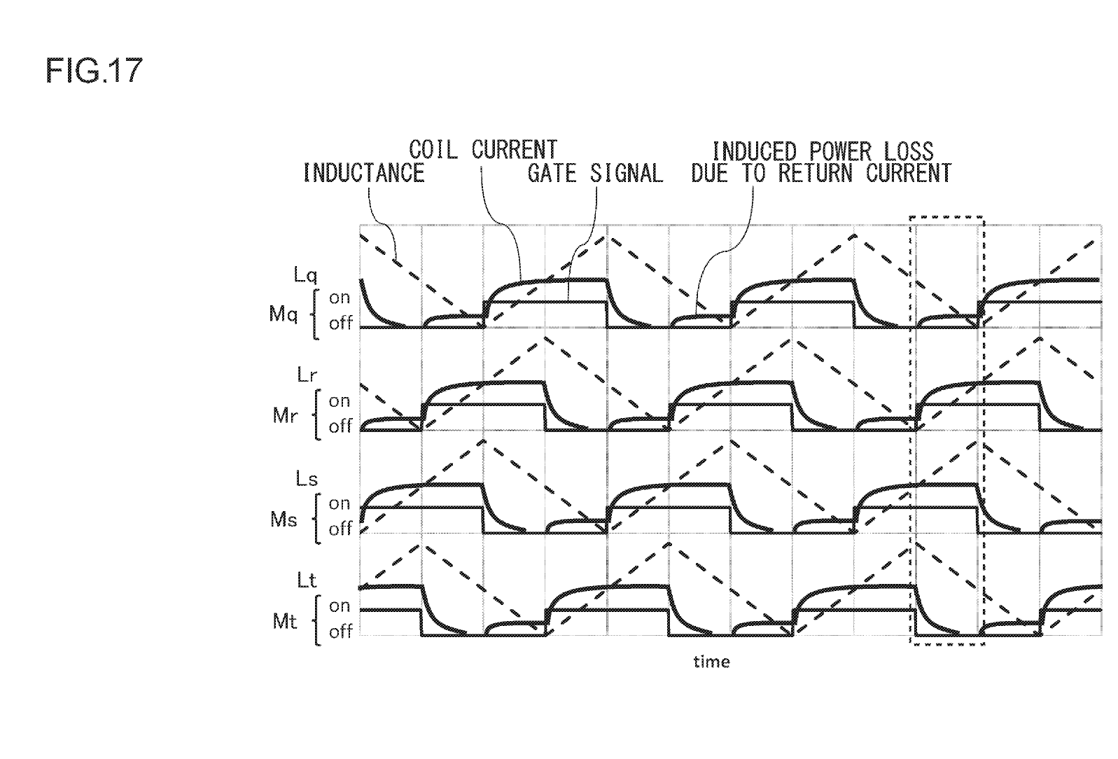

FIG. 17 is a diagram that shows operation timing of the drive circuit 200 shown in FIG. 16. The Q-phase switching element Mq, R-phase switching element Mr, S-phase switching element Ms, and T-phase switching element Mt are controlled with 180-degree conduction.

Also, the Q-phase switching element Mq, R-phase switching element Mr, S-phase switching element Ms, and T-phase switching element Mt are driven so that the respective phases are shifted by 90 degrees. More specifically, an ON period of the Q-phase switching element Mq is delayed by 90 degrees from an ON period of the R-phase switching element Mr, the ON period of the R-phase switching element Mr is delayed by 90 degrees from an ON period of the S-phase switching element Ms, the ON period of the S-phase switching element Ms is delayed by 90 degrees from an ON period of the T-phase switching element Mt, and the ON period of the T-phase switching element Mt is delayed by 90 degrees from another ON period of the Q-phase switching element Mq. Accordingly, the four phase coils of the T-phase coil Lt, S-phase coil Ls, R-phase coil Lr, and Q-phase coil Lq are excited in this order at different times shifted by 90 degrees as the electric angle.

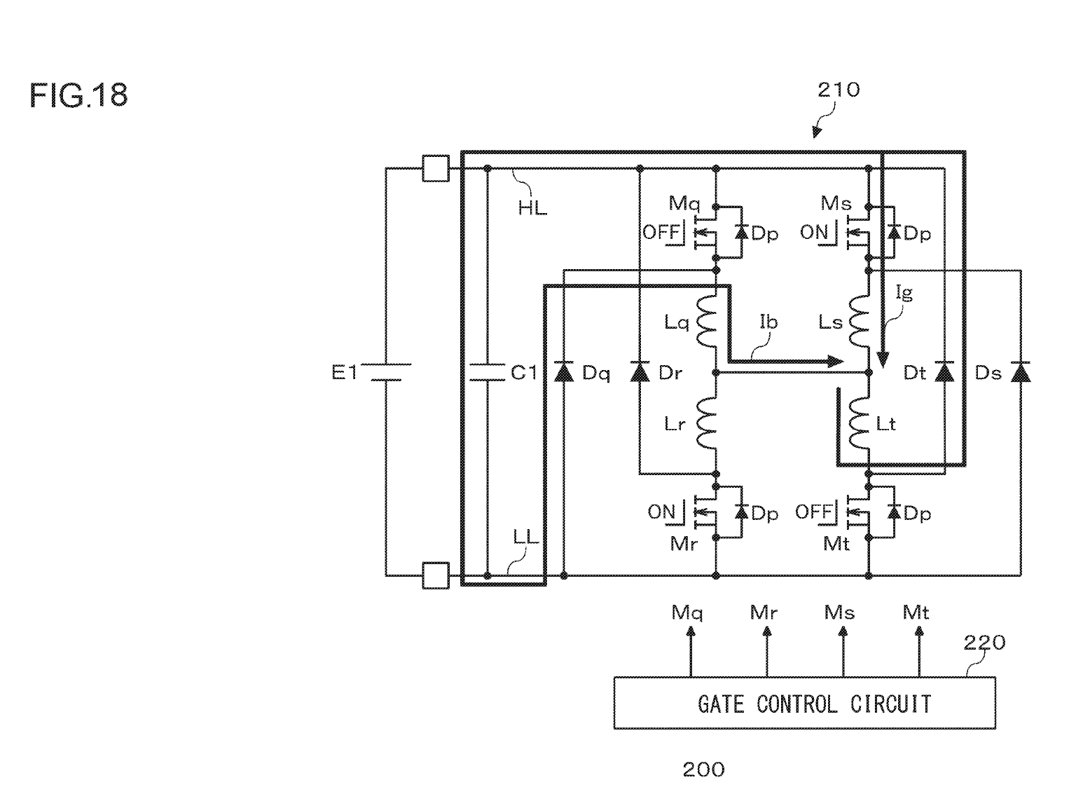

FIG. 18 is a diagram used to describe a problem of the drive circuit 200 shown in FIG. 16. Also see FIG. 17 that shows timing of phase current flowing through each phase coil of the drive circuit 200. FIG. 18 shows return paths of an induced current generated by an induced voltage in the T-phase coil Lt, in the state where the Q-phase switching element Mq is OFF, the R-phase switching element Mr is ON, the S-phase switching element Ms is ON, and the T-phase switching element Mt is OFF (see the dotted frame in FIG. 17). Although not illustrated, the power supply current flows through a path from the S-phase switching element Ms via the S-phase coil Ls and R-phase coil Lr to the R-phase switching element Mr so as to excite the S-phase coil Ls and R-phase coil Lr.

An induced current generated by an induced voltage in the T-phase coil Lt returns through a first return path Ig from the T-phase current control element Dt via the S-phase switching element Ms and S-phase coil Ls to the T-phase coil Lt. The induced current also returns through a second return path Ib from the T-phase current control element Dt via the capacitor C1, R-phase current control element Dr, and Q-phase coil Lq to the T-phase coil Lt. The first return path Ig is a return path that does not negatively affect the excitation of other phases (hereinafter, referred to as a positive torque return path in the present specification). On the other hand, the second return path Ib is a return path that negatively affects the excitation of other phases (hereinafter, referred to as a negative torque return path in the present specification).

Through the second return path Ib, a return current in the previous step flows into a negative torque (power generation) region of the Q-phase coil Lq before excitation, causing induced power as a loss. As shown in FIG. 17, induced power loss is caused by a return current in the previous step, in each phase coil before a conduction period. In the following, a method for preventing such induced power loss will be described.

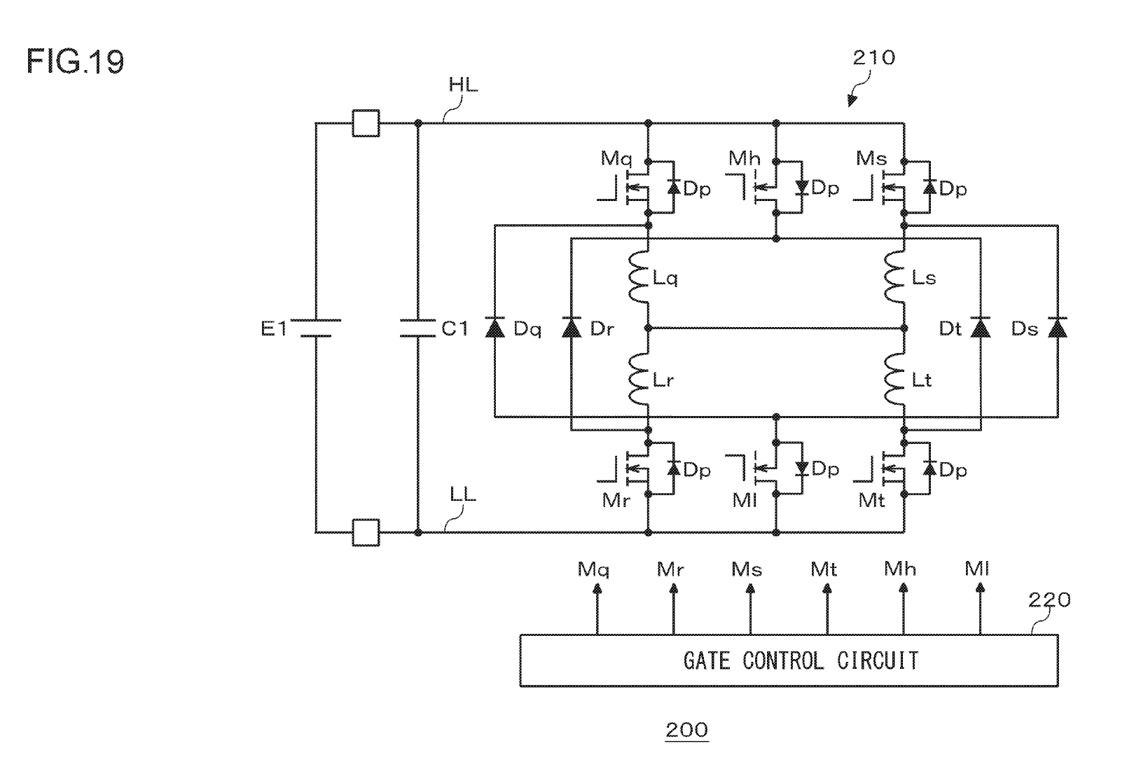

FIG. 19 is a diagram that shows a circuit configuration of the drive circuit 200 according to an embodiment 4, which drives the SR motor 100 shown in FIGS. 1A and 1B. In the following, differences from the circuit configuration of the drive circuit 200 according to the comparative example 3 shown in FIG. 16 will be described.

In the embodiment 4, between the anode terminal of the Q-phase current control element Dq as well as the anode terminal of the S-phase current control element Ds and the low side reference line LL, a low side switching element Ml is provided. Similarly, between the cathode terminal of the R-phase current control element Dr as well as the cathode terminal of the T-phase current control element Dt and the high side reference line HL, a high side switching element Mh is provided.

In FIG. 19, n-channel MOSFETs are used for the high side switching element Mh and low side switching element Ml. The source terminal of the high side switching element Mh is connected to the high side reference line HL, and the drain terminal of the high side switching element Mh is connected to the cathode terminal of the R-phase current control element Dr and the cathode terminal of the T-phase current control element Dt so that no current flows through the parasitic diode Dp when the high side switching element Mh is in the OFF state. Similarly, the drain terminal of the low side switching element Ml is connected to the low side reference line LL, and the source terminal of the low side switching element Ml is connected to the anode terminal of the Q-phase current control element Dq and the anode terminal of the S-phase current control element Ds so that no current flows through the parasitic diode Dp when the low side switching element Ml is in the OFF state. The gate control circuit 220 controls the ON/OFF state of the Q-phase switching element Mq, R-phase switching element Mr, S-phase switching element Ms, T-phase switching element Mt, high side switching element Mh, and low side switching element Ml.

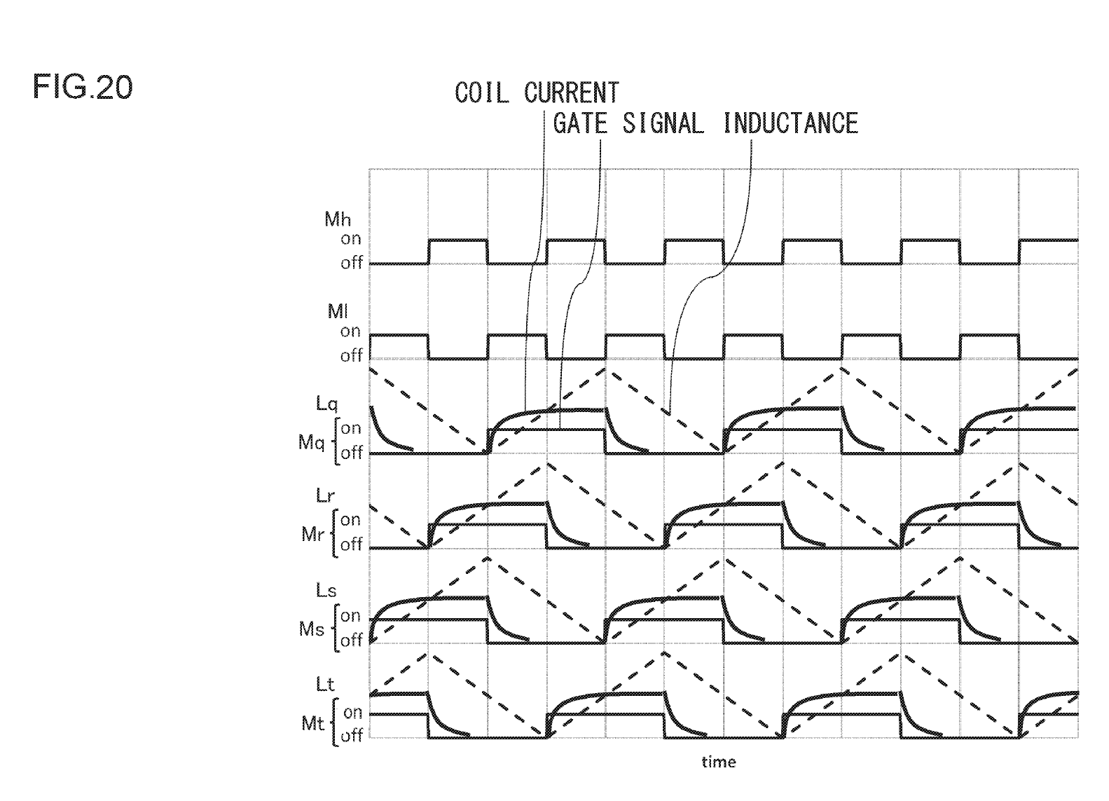

FIG. 20 is a diagram that shows operation timing of the drive circuit 200 shown in FIG. 19. The drive timing of each of the Q-phase switching element Mq, R-phase switching element Mr, S-phase switching element Ms, and T-phase switching element Mt is identical with that shown in FIG. 17.

For a current emission period based on an induced voltage in the Q-phase coil Lq after the Q-phase switching element Mq is turned off, the high side switching element Mh is turned off so as to break the negative torque return path including the R-phase coil Lr and R-phase current control element Dr. Thereafter, when a conduction period of the R-phase coil Lr is started, the high side switching element Mh is turned on again.

For a current emission period based on an induced voltage in the R-phase coil Lr after the R-phase switching element Mr is turned off, the low side switching element Ml is turned off so as to break the negative torque return path including the S-phase current control element Ds and S-phase coil Ls. Thereafter, when a conduction period of the S-phase coil Ls is started, the low side switching element Mh is turned on again.

For a current emission period based on an induced voltage in the S-phase coil Ls after the S-phase switching element Ms is turned off, the high side switching element Mh is turned off so as to break the negative torque return path including the T-phase coil Lt and T-phase current control element Dt. Thereafter, when a conduction period of the T-phase coil Lt is started, the high side switching element Mh is turned on again.

For a current emission period based on an induced voltage in the T-phase coil Lt after the T-phase switching element Mt is turned off, the low side switching element Ml is turned off so as to break the negative torque return path including the Q-phase current control element Dq and Q-phase coil Lq. Thereafter, when a conduction period of the Q-phase coil Lq is started, the low side switching element Mh is turned on again.

Thus, the high side switching element Mh and the low side switching element Ml in the four-phase driving system are complimentarily turned on or off with twice the frequency of the Q-phase switching element Mq, R-phase switching element Mr, S-phase switching element Ms, and T-phase switching element Mt.

As stated above, according to the embodiment 4, generation of induced power can be prevented by breaking a negative torque return path with proper timing using a switching element. Accordingly, a decline in motor efficiency can also be prevented. Also, in the case of the four-phase system, the SR motor 100 can be efficiently driven with six MOSFETs, four diodes, and four wire harnesses. The circuit configuration according to the embodiment 4 is applicable to a general circuit configuration with an even number, which is four or greater, of phases. Even in the case of six or more phases, control is provided so that coils are excited while changing a pair of two phase coils of an upper phase coil and a lower phase coil, in the same way as the case of four phases.

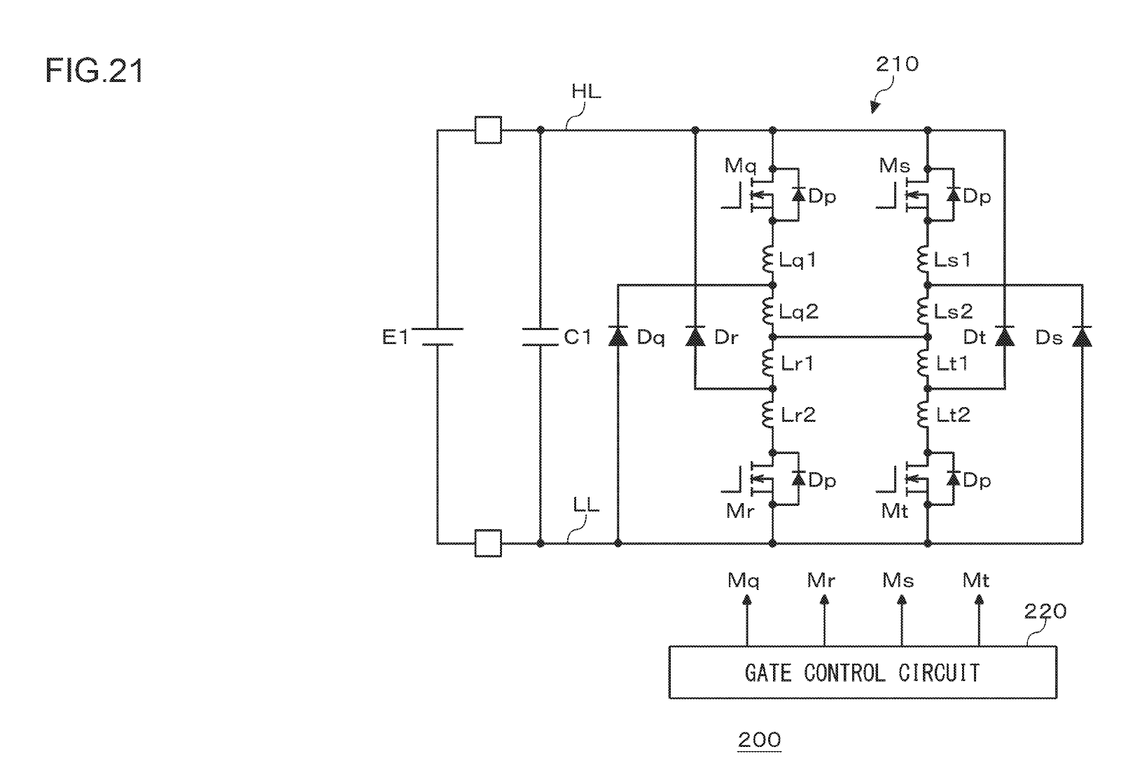

FIG. 21 is a diagram that shows a circuit configuration of the drive circuit 200 according to an embodiment 5, which drives the SR motor 100 shown in FIGS. 6A and 6B. The drive circuit 200 according to the embodiment 5 is a circuit formed by combining the essential part of the drive circuit 200 according to the comparative example 3 shown in FIG. 16 and the essential part of the drive circuit 200 according to the embodiment 1 shown in FIG. 7.

In the comparative example 3, the Q-phase current control element Dq is provided between the upper end of the Q-phase coil Lq and the low side reference line LL; however, in the embodiment 5, the Q-phase current control element Dq is provided between the junction point of the Q-phase coil Lq and the low side reference line LL. Similarly, the R-phase current control element Dr is provided between the junction point of the R-phase coil Lr and the high side reference line HL; the S-phase current control element Ds is provided between the junction point of the S-phase coil Ls and the low side reference line LL; and the T-phase current control element Dt is provided between the junction point of the T-phase coil Lt and the high side reference line HL.

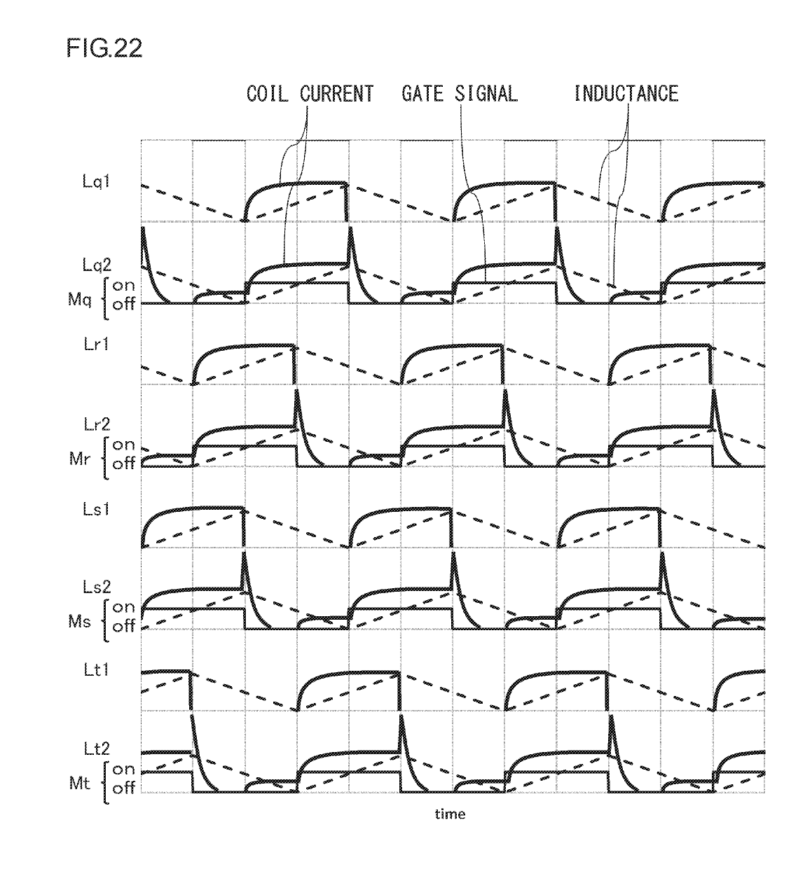

FIG. 22 is a diagram that shows operation timing of the drive circuit 200 shown in FIG. 21. The operation timing shown in FIG. 22 includes both the features of the operation timing shown in FIG. 8 and the features of the operation timing shown in FIG. 17. Also, the effects provided by the drive circuit 200 according to the embodiment 5 include both the effects provided by the drive circuit 200 according to the comparative example 3 and the effects provided by the drive circuit 200 according to the embodiment 1.

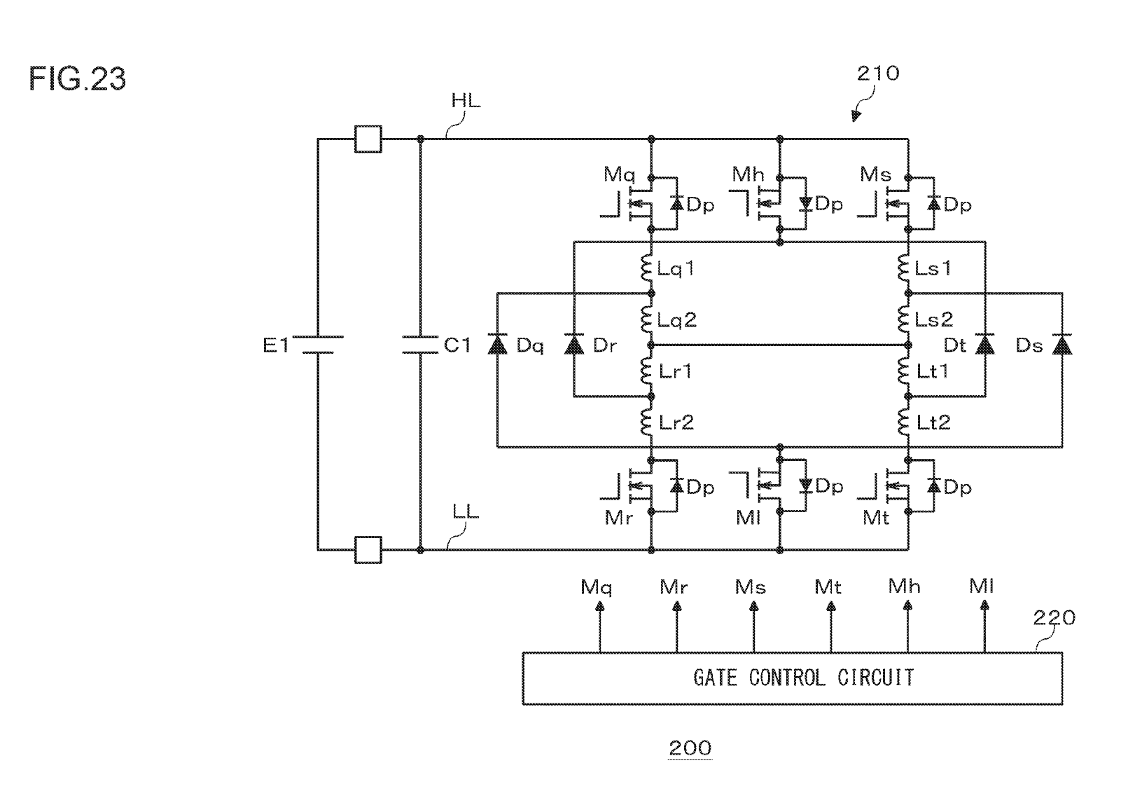

FIG. 23 is a diagram that shows a circuit configuration of the drive circuit 200 according to an embodiment 6, which drives the SR motor 100 shown in FIGS. 6A and 6B. The drive circuit 200 according to the embodiment 6 is a circuit formed by combining the essential part of the drive circuit 200 according to the embodiment 4 shown in FIG. 19 and the essential part of the drive circuit 200 according to the embodiment 5 shown in FIG. 21.

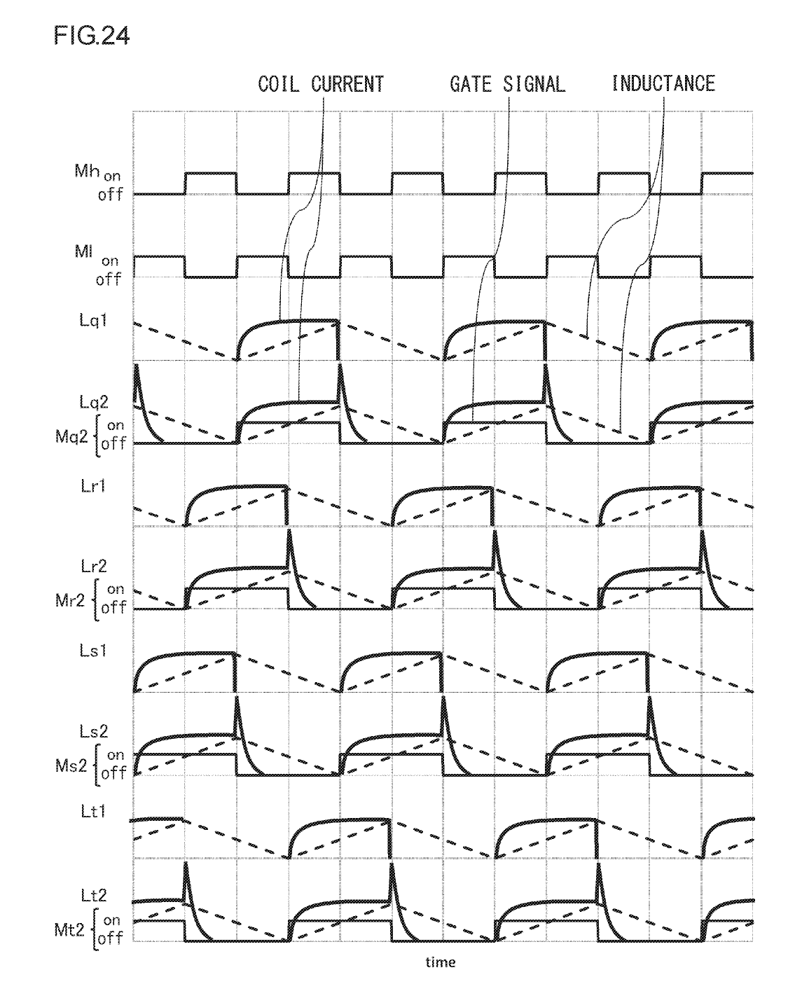

FIG. 24 is a diagram that shows operation timing of the drive circuit 200 shown in FIG. 23. The operation timing shown in FIG. 24 includes both the features of the operation timing shown in FIG. 20 and the features of the operation timing shown in FIG. 22. Also, the effects provided by the drive circuit 200 according to the embodiment 6 include both the effects provided by the drive circuit 200 according to the embodiment 4 and the effects provided by the drive circuit 200 according to the embodiment 5.

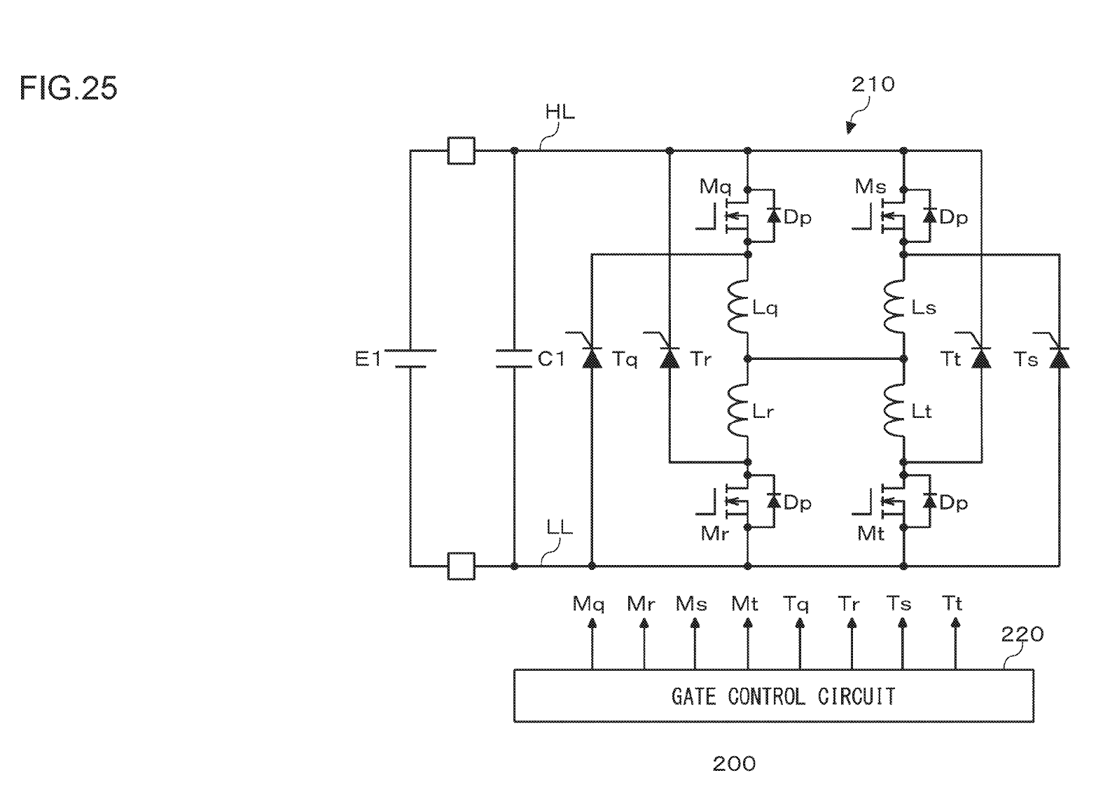

FIG. 25 is a diagram that shows a circuit configuration of the drive circuit 200 according to an embodiment 7, which drives the SR motor 100 shown in FIGS. 1A and 1B. The drive circuit 200 according to the embodiment 7 is a circuit that employs thyristors, instead of diodes, for the Q-phase current control element Dq, R-phase current control element Dr, S-phase current control element Ds, and T-phase current control element Dt in the drive circuit 200 according to the embodiment 4 shown in FIG. 19. By supplying a gate signal to the gate terminal of each of a Q-phase thyristor Tq, an R-phase thyristor Tr, an S-phase thyristor Ts, and a T-phase thyristor Tt, the gate control circuit 220 controls conduction or non-conduction of each of the thyristors.

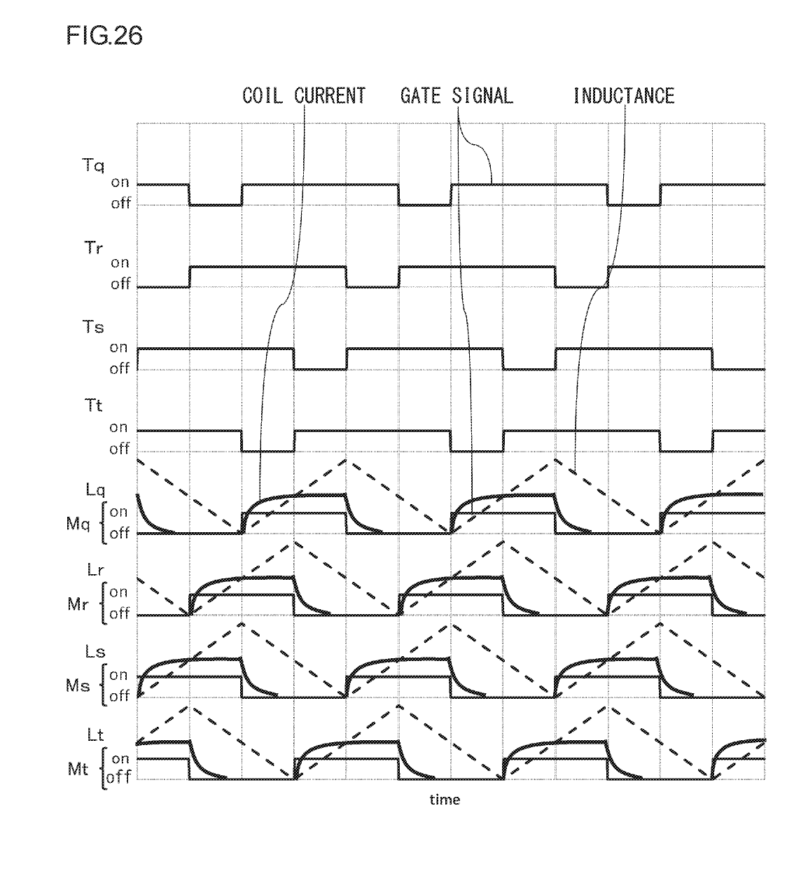

FIG. 26 is a diagram that shows operation timing of the drive circuit 200 shown in FIG. 25. In the operation timing shown in FIG. 26, the Q-phase thyristor Tq, R-phase thyristor Tr, S-phase thyristor Ts, and T-phase thyristor Tt are used instead of the high side switching element Mh and low side switching element Ml to implement the operation timing shown in FIG. 20.

As with in the embodiment 4, generation of induced power can be prevented by breaking a negative torque return path with proper timing by using a thyristor in the embodiment 7. Although the number of MOSFETs can be reduced in the embodiment 7 compared to the embodiment 4, power consumption of a gate driver is smaller in the embodiment 4 than in the embodiment 7.

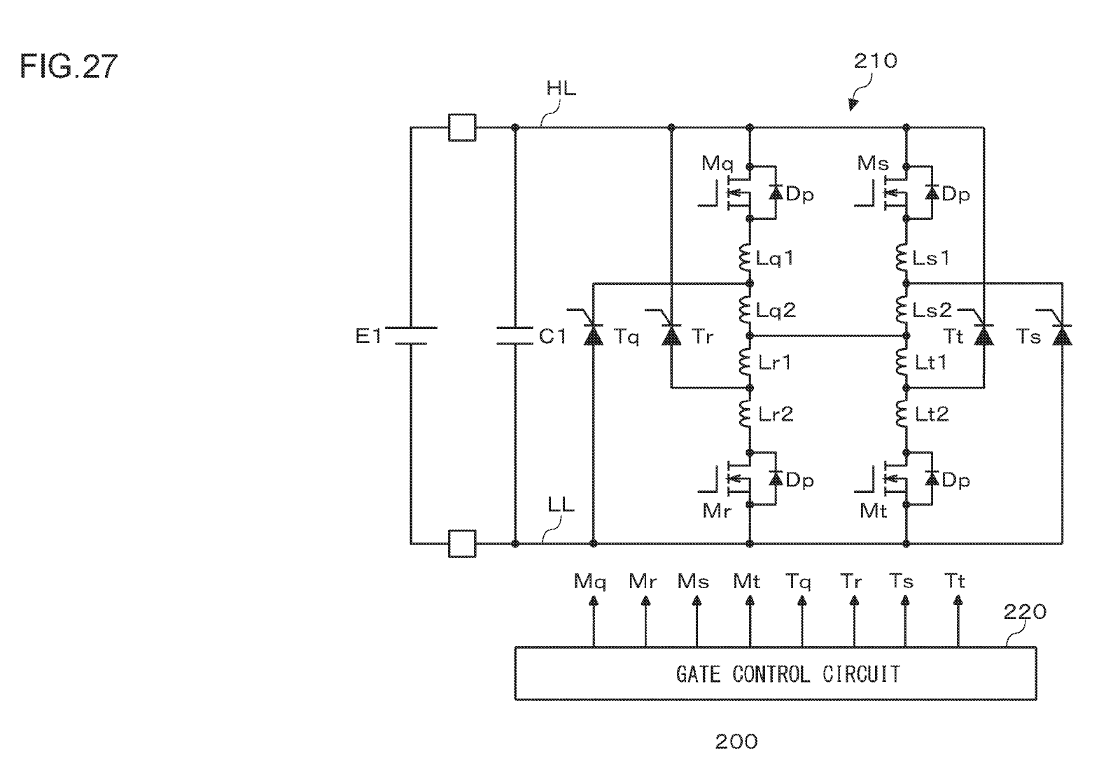

FIG. 27 is a diagram that shows a circuit configuration of the drive circuit 200 according to an embodiment 8, which drives the SR motor 100 shown in FIGS. 6A and 6B. The drive circuit 200 according to the embodiment 8 is a circuit formed by combining the essential part of the drive circuit 200 according to the comparative example 7 shown in FIG. 25 and the essential part of the drive circuit 200 according to the embodiment 1 shown in FIG. 7.

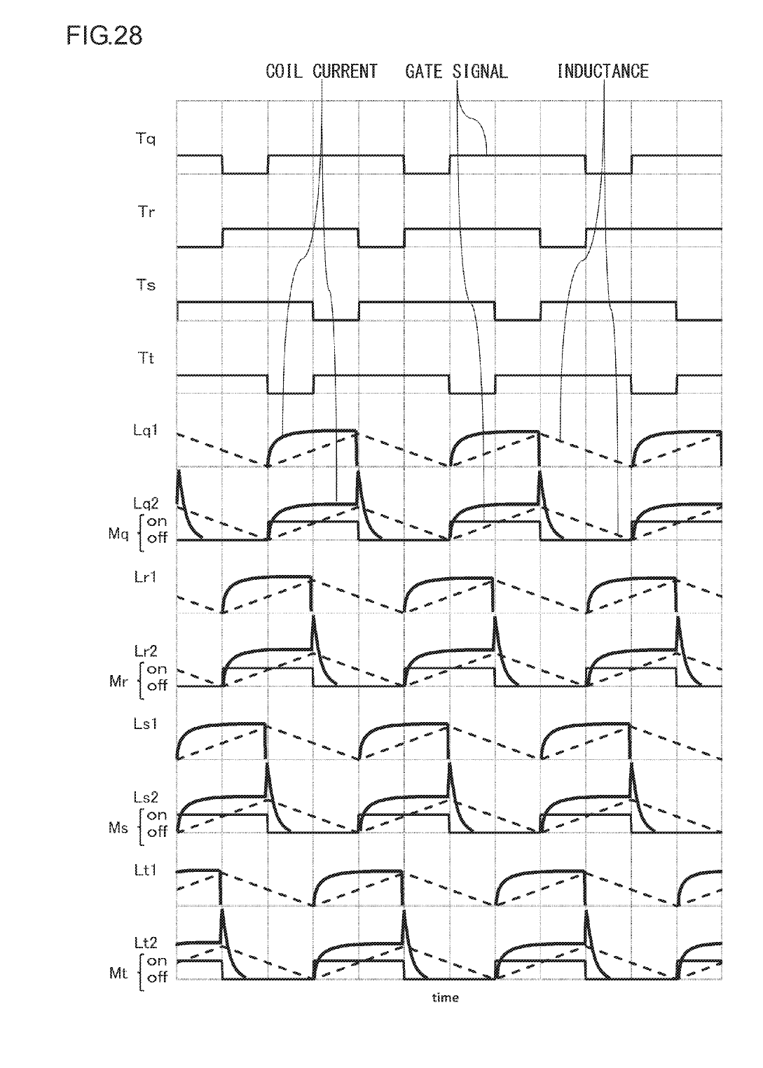

FIG. 28 is a diagram that shows operation timing of the drive circuit 200 shown in FIG. 27. The operation timing shown in FIG. 28 includes both the features of the operation timing shown in FIG. 8 and the features of the operation timing shown in FIG. 26. Also, the effects provided by the drive circuit 200 according to the embodiment 8 include both the effects provided by the drive circuit 200 according to the embodiment 7 and the effects provided by the drive circuit 200 according to the embodiment 1.

With the drive circuit 200 according to the modification 2 shown in FIG. 15, an example has been described in which the first current control element D1 (diode) of each phase is changed to the fourth switching element M4 (n-channel MOSFET) in the drive circuit 200 according to the embodiment 1 shown in FIG. 7. The drive circuit 200 shown in FIG. 15 has the high speed rotation mode in which, when a coil is excited, the relevant fourth switching element M4 is turned on so as to halve the number of turns of the coil through which a current for excitation flows, thereby reducing a current rise time. The drive circuit 200 also has the normal rotation mode in which, when a coil is excited, the relevant fourth switching element M4 is not turned on so that a current for excitation flows through the whole coil.

In the high speed rotation mode, both the number of turns of a coil through which a current for excitation flows and the number of turns of the coil through which a current for demagnetization flows are halved, so that both a current rise and a current fall become steep (see FIG. 12). In the normal rotation mode, on the other hand, a current for excitation flows through a whole coil while a current for demagnetization flows through a half of the coil, so that only a current fall becomes steep (see FIG. 8). The drive circuit 200 according to the embodiment 1 shown in FIG. 7 only has the normal rotation mode. Since the first current control element D1 (diode) of each phase is changed to the fourth switching element M4 (n-channel MOSFET), the drive circuit 200 according to the modification 2 shown in FIG. 15 can provide the two types of output characteristics. In the following, another circuit configuration for providing two types of output characteristics will be described.

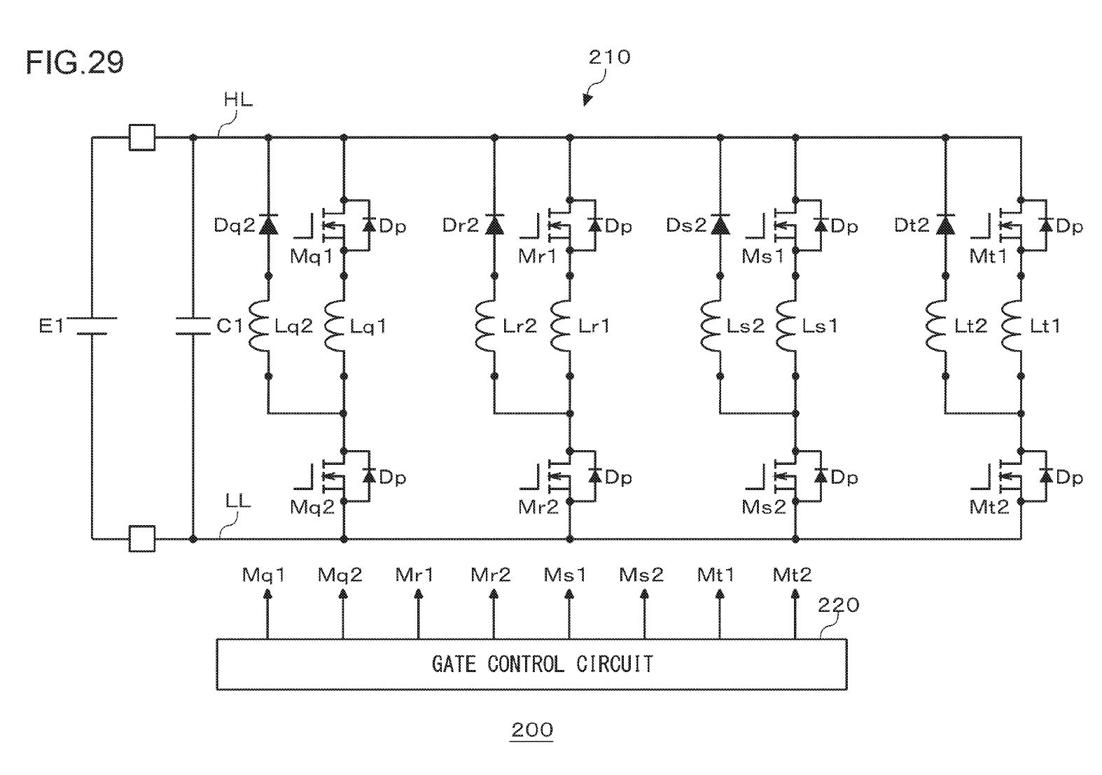

FIG. 29 is a diagram that shows a circuit configuration of the drive circuit 200 according to a modification of the modification 2. Although FIG. 29 shows a circuit configuration for a four-phase system, the configuration is also applicable to a system with another number of phases. In the configuration of the drive circuit 200 shown in FIG. 29, the second switching elements M2 are removed from the drive circuit 200 shown in FIG. 15. Accordingly, the number of MOSFETs can be reduced in the drive circuit 200 shown in FIG. 29 compared to the drive circuit 200 shown in FIG. 15. Also, the number of diodes can be reduced in the drive circuit 200 shown in FIG. 29 compared to the drive circuit 200 according to the comparative example 1 shown in FIG. 2. Therefore, the circuit size and costs can be reduced.

The drive circuit 200 shown in FIG. 29 can also provide two types of output characteristics. One type is a high speed rotation mode, which is equivalent to the high speed rotation mode of the drive circuit 200 shown in FIG. 15. More specifically, for excitation, the first switching element M1 and the second switching element M2 are turned on in each phase so that a current for excitation flows through the first coil section L1, and, for demagnetization, the first switching element M1 is turned off and the second switching element M2 is turned on in each phase so that a current for demagnetization flows through the second coil section L2.

The other type is a two-coil circulation chopping mode. In this mode, for excitation, turning on and turning off of the second switching element M2 are alternately repeated (chopping) while the first switching element M1 is in the ON state in each phase. When the first switching element M1 is ON and the second switching element M2 is OFF, a current circularly flows through the first switching element M1, the first coil section L1, the second coil section L2, the first current control element D1, and the first switching element M1 again so as to flow through the two coils.

In this way, the two-coil circulation chopping mode alternately repeats an excitation state in which the first switching element M1 and second switching element M2 are ON, and a circulation state in which the first switching element M1 is ON and the second switching element M2 is OFF. The magnetic flux energy is the same both in the excitation state and in the circulation state, and the number of turns of a coil through which a current flows is doubled in the circulation state. Accordingly, a current flowing through the first coil section L1 and second coil section L2 is halved in the circulation state. Further, a current obtained by averaging a current flowing in the excitation state and a current flowing in the circulation state is also lower than a current flowing when a coil is excited in the high speed rotation mode. For demagnetization, as with in the high speed rotation mode, the first switching element M1 is turned off and the second switching element M2 is turned on so that a current for demagnetization flows through the second coil section L2. In the chopping mode, the output characteristics can be changed by changing an ON/OFF duty ratio.

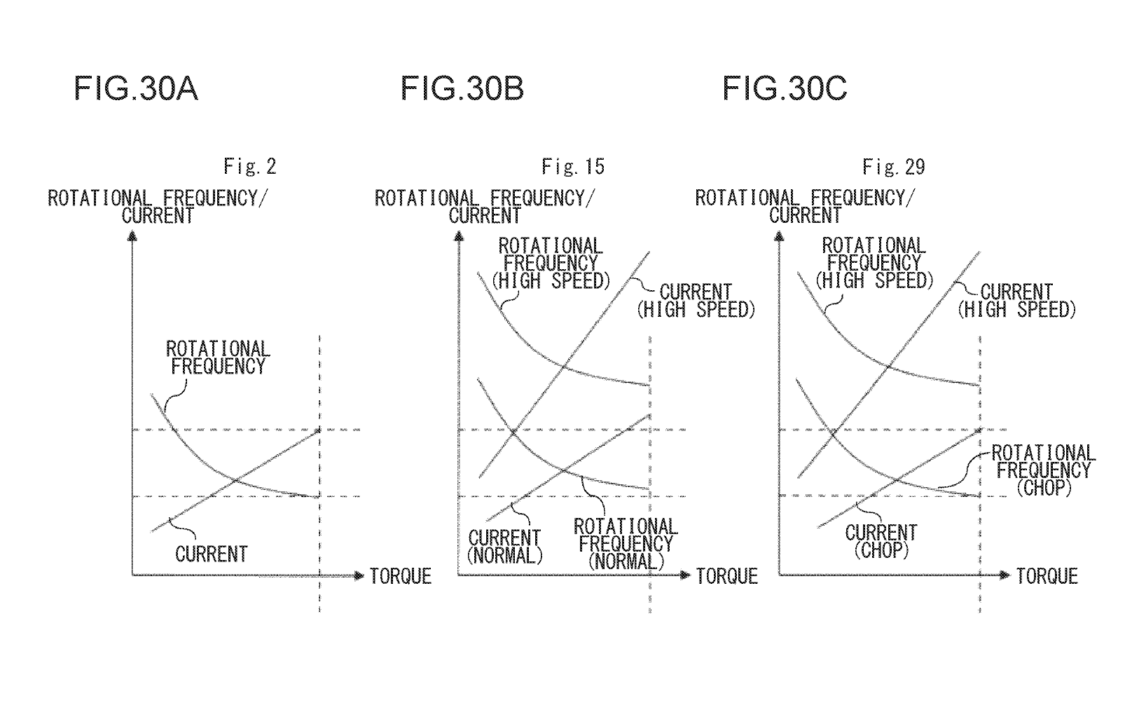

FIGS. 30A-30C are diagrams in which output characteristics of the drive circuits 200 shown in FIGS. 2, 15, and 29 are compared with one another. FIG. 30C shows the case where the drive circuit shown in FIG. 29 is operated at the duty ratio of 50%. The horizontal axis represents the torque, and the vertical axis represents the rotational frequency or current. The drive circuit 200 shown in FIG. 2, of which the output characteristics are shown in FIG. 30A, has one mode. The drive circuit 200 shown in FIG. 15, of which the output characteristics are shown in FIG. 30B, has two modes of the normal rotation mode and the high speed rotation mode. The drive circuit 200 shown in FIG. 29, of which the output characteristics are shown in FIG. 30C, has two modes of the high speed rotation mode and the two-coil circulation chopping mode.

When the output characteristics shown in FIG. 30A are compared to the output characteristics in the normal rotation mode shown in FIG. 30B, the outputs are improved by several percent in FIG. 30B. This is because, since the current convergence time is reduced and the excitation time is increased, the rotational frequency can be increased by several percent in the case of FIG. 30B. When the output characteristics shown in FIG. 30A are compared to the output characteristics in the high speed rotation mode shown in FIG. 30B, the rotational frequency is almost doubled in FIG. 30B.

Meanwhile, the output characteristics in the high speed rotation mode shown in FIG. 30B are nearly identical with those in the high speed rotation mode shown in FIG. 30C. Also, the output characteristics shown in FIG. 30A are nearly identical with the output characteristics in the two-coil circulation chopping mode shown in FIG. 30C.

Thus, with the drive circuit 200 shown in FIG. 29, a drive circuit 200 with two types of output characteristics including the high speed rotation mode can be implemented at low cost. Also, since the high speed rotation mode and the two-coil circulation chopping mode can be switched therebetween only by turning on and off the second switching element, the configuration of the gate control apparatus can be simplified.

A drive circuit for a reluctance motor of the following embodiment may also be configured.

One embodiment of the present invention is a drive circuit for a reluctance motor comprising a stator having a plurality of salient poles and a rotor having a plurality of salient poles, and the drive circuit comprises: a first switching element provided between a first end of a coil wound around a salient pole of the stator or the rotor and a high side reference line connected to the positive side of a power supply; a second switching element provided between a second end of the coil and a low side reference line connected to the negative side of the power supply; a first current control element that sends a current from the low side reference line to a first connection point in the coil; and a second current control element that sends a current from a second connection point of the coil to the high side reference line. The first connection point of the coil is positioned closer to the first end of the coil than the second connection point is, and the number of turns between the first connection point and the second connection point is smaller than the number of turns between the first end and the second end of the coil. The winding may be provided around a salient pole of the stator or may be provided around a salient pole of the rotor.

According to this embodiment, when a coil is demagnetized, an induced current can be emitted using a smaller number of turns of the coil, so that a period until the current converges can be reduced. Therefore, a longer excitation time can be ensured, and the output characteristics can be improved.

The first current control element may be a first diode of which the anode terminal is connected to the low side reference line and of which the cathode terminal is connected to the first connection point of the coil. Also, the second current control element may be a second diode of which the anode terminal is connected to the second connection point of the coil and of which the cathode terminal is connected to the high side reference line. Accordingly, a return path used when the coil is demagnetized can be formed.

The first connection point may be set to the first end of the coil, and the second connection point may be set to the midpoint of the coil. Also, the first connection point may be set to the midpoint of the coil, and the second connection point may be set to the second end of the coil. Accordingly, only one junction point is provided in the coil.

The first switching element, the second switching element, the first current control element, and the second current control element may be provided for each phase of the stator. Also, the first switching element or the second switching element may be shared in a plurality of phases in which excitation periods of the coils do not overlap with each other. Accordingly, the number of switching elements can be reduced.

The second current control element may be a third switching element with which a diode is formed or connected in parallel. For at least part of a period in which the coil is excited, the second switching element and the third switching element may be turned on and the first switching element may be turned off. Accordingly, a current rise time when the coil is excited can be reduced.

The second connection point of the coil may be provided between the first connection point and the second end of the coil. Also, the first current control element may be a fourth switching element with which a diode is formed or connected in parallel. For at least part of a period in which the coil is excited, the fourth switching element and the first switching element may be turned on and the second switching element may be turned off. Accordingly, a current rise time when the coil is excited can be reduced.

A drive circuit for a reluctance motor of the following embodiment may also be configured.

A drive circuit for a reluctance motor comprising a stator having a plurality of salient poles and a rotor having a plurality of salient poles, comprising:

a first switching element provided between a first end of a first coil wound around a salient pole of a first stator or a first rotor and a high side reference line connected to the positive side of a power supply;

a second switching element provided between a second end of a second coil wound around a salient pole of a second stator or a second rotor and a low side reference line connected to the negative side of the power supply;

a third switching element provided between a first end of a third coil wound around a salient pole of a third stator or a third rotor and the high side reference line;

a fourth switching element provided between a second end of a fourth coil wound around a salient pole of a fourth stator or a fourth rotor and the low side reference line;

a first current control element that sends a current from the low side reference line to the first end of the first coil;

a second current control element that sends a current from the second end of the second coil to the high side reference line;

a third current control element that sends a current from the low side reference line to the first end of the third coil; and

a fourth current control element that sends a current from the second end of the fourth coil to the high side reference line, wherein:

the second end of the first coil, the first end of the second coil, the second end of the third coil, and the first end of the fourth coil are electrically connected; and

each of the first current control element, the second current control element, the third current control element, and the first current control element can be controlled to be a non-conduction state.

Further, a drive circuit for a reluctance motor of the following embodiment may also be configured.

A drive circuit for a reluctance motor comprising a stator having a plurality of salient poles and a rotor having a plurality of salient poles, comprising:

a first switching element provided between a first end of a first coil wound around a salient pole of a first stator or a first rotor and a high side reference line connected to the positive side of a power supply;

a second switching element provided between a second end of a second coil wound around a salient pole of a second stator or a second rotor and a low side reference line connected to the negative side of the power supply;

a third switching element provided between a first end of a third coil wound around a salient pole of a third stator or a third rotor and the high side reference line;

a fourth switching element provided between a second end of a fourth coil wound around a salient pole of a fourth stator or a fourth rotor and the low side reference line;

a first current control element that sends a current from the low side reference line to the first end of the first coil;

a second current control element that sends a current from the second end of the second coil to the high side reference line;

a third current control element that sends a current from the low side reference line to the first end of the third coil; and

a fourth current control element that sends a current from the second end of the fourth coil to the high side reference line,

wherein the second end of the first coil, the first end of the second coil, the second end of the third coil, and the first end of the fourth coil are electrically connected, and the drive circuit further comprising:

a fifth switching element provided between the first current control element as well as the third current control element and the low side reference line; and

a sixth switching element provided between the second current control element as well as the fourth current control element and the high side reference line.

What is claimed is:

1. A drive circuit for a reluctance motor comprising a stator having a plurality of salient poles and a rotor having a plurality of salient poles, the drive circuit comprising:
a first path used to supply a current for excitation that flows through at least part of a coil wound around a salient pole of the stator or the rotor; and
a second path used to supply a current for demagnetization that flows through a different part of the coil that does not coincide with the at least part of the coil.

2. The drive circuit for a reluctance motor of claim 1, comprising:
a first switching element provided between a first end of the coil and a high side reference line connected to the positive side of a power supply;
a current control element provided between a second end of the coil and the high side reference line to send a current from the coil to the high side reference line; and
a second switching element provided between a connection point in the coil and a low side reference line connected to the negative side of the power supply.

3. The drive circuit for a reluctance motor of claim 2, having a mode in which the first switching element and the second switching element are turned on and a mode in which turning on and turning off of the second switching element are alternately repeated while the first switching element is in the ON state, when the coil is excited.

4. The drive circuit for a reluctance motor of claim 1, comprising:
a first switching element provided between a first end of the coil and a high side reference line connected to the positive side of a power supply;
a second switching element provided between a second end of the coil and a low side reference line connected to the negative side of the power supply;
a first current control element that sends a current from the low side reference line to a first connection point in the coil; and
a second current control element that sends a current from a second connection point of the coil that is positioned closer to the second end than the first connection point is, to the high side reference line.

5. The drive circuit for a reluctance motor of claim 4, wherein:
the first current control element is a first diode of which the anode terminal is connected to the low side reference line and of which the cathode terminal is connected to the connection point of the coil; and
the second current control element is a second diode of which the anode terminal is connected to the connection point of the coil and of which the cathode terminal is connected to the high side reference line.

6. The drive circuit for a reluctance motor of claim 4, wherein:
the first current control element is a third switching element with which a diode is formed or connected in parallel; and
the second current control element is a second diode of which the anode terminal is connected to the connection point of the coil and of which the cathode terminal is connected to the high side reference line.

7. The drive circuit for a reluctance motor of claim 1, having two modes in which the number of turns used for excitation of the coil is different.

8. The drive circuit for a reluctance motor of claim 4, wherein:
the first switching element, the second switching element, the first current control element, and the second current control element are provided for each phase of the stator; and
the first switching element or the second switching element is shared in a plurality of phases in which excitation periods of the coils do not overlap with each other.

9. A drive circuit for a reluctance motor comprising a stator having a plurality of salient poles and a rotor having a plurality of salient poles, the drive circuit comprising:
a first path used to supply a current from a high side reference line connected to the positive side of a power supply, via at least part of a coil wound around a salient pole of the stator or the rotor, to a low side reference line connected to the negative side of the power supply;
a second path used to supply a current from the low side reference line, via a different part of the coil that does not coincide with the at least part of the coil, to the high side reference line; and
switching means that performs switching between the connection of the first path and the connection of the second path, wherein:
inductance in the second path is less than or equal to inductance in the first path; and
the direction of a current flowing through the coil is the same in the first path and the second path.

10. A reluctance motor system, comprising:
a reluctance motor comprising a stator having a plurality of salient poles and a rotor having a plurality of salient poles; and
the drive circuit of claim 1 that drives the reluctance motor.

11. A reluctance motor system, comprising:
a reluctance motor comprising a stator having a plurality of salient poles and a rotor having a plurality of salient poles; and
the drive circuit of claim 9 that drives the reluctance motor.
